(19) United States
(12) Patent Application Publication
(10) Pub. No.: US 2024/0003275 A1
(43) Pub. Date: Jan. 4, 2024

(54) ACOUSTIC IMPEDANCE CHANGE STRUCTURE AND AIR PASSAGE TYPE SILENCER

(71) Applicant: FUJIFILM Corporation, Tokyo (JP)

(72) Inventors: Shinya HAKUTA, Ashigarakami-gun (JP); Shogo YAMAZOE, Ashigarakami-gun (JP); Yoshihiro SUGAWARA, Ashigarakami-gun (JP); Yuichiro ITAI, Ashigarakami-gun (JP)

(73) Assignee: FUJIFILM Corporation, Tokyo (JP)

(21) Appl. No.: 18/469,270

(22) Filed: Sep. 18, 2023

Related U.S. Application Data
(63) Continuation of application No. PCT/JP2022/013870, filed on Mar. 24, 2022.

(30) Foreign Application Priority Data
Mar. 25, 2021 (JP) 2021-050890

(51) Int. Cl. F01N 1/04

(52) U.S. Cl. CPC F01N 1/04; F01N 2490/16; F01N 2490/18

(57) ABSTRACT

To provide an air passage type silencer and an acoustic impedance change structure of which the absorbance is high, that suppresses generation of a wind noise, and that has a high sound attenuation effect in a low-frequency band. Provided is an acoustic impedance change structure through which a sound propagates, the acoustic impedance change structure including at least in this order: a first impedance matching region that is connected to an inlet portion and in which an acoustic impedance gradually decreases; an acoustic impedance constancy region; and an outlet portion, in which Z_{cham}<Zᵢₙ and Z_{cham}<Zₒᵤₜ are satisfied, where Zᵢₙ is an acoustic impedance in the inlet portion, Z_{cham} is an acoustic impedance in the acoustic impedance constancy region, and Zₒᵤₜ is an acoustic impedance in the outlet portion, and a first terminal structure acoustically connected to the acoustic impedance constancy region is provided.

### CROSS-REFERENCE TO RELATED APPLICATIONS

This application is a Continuation of PCT International Application No. PCT/JP2022/013870 filed on Mar. 24, 2022, which claims priority under 35 U.S.C. § 119(a) to Japanese Patent Application No. 2021-050890 filed on Mar. 25, 2021. The above applications are hereby expressly incorporated by reference, in their entirety, into the present application.

### BACKGROUND OF THE INVENTION

### 1. Field of the Invention

The present invention relates to an acoustic impedance changing structure and an air passage type silencer.

### 2. Description of the Related Art

As a silencer that attenuates a noise from a gas supply source or the like at a ventilation path intermediate position of a ventilation pipe through which a gas is transported, a cavity type silencer that is installed at a ventilation path intermediate position and that includes an expansion chamber of which the cross-sectional area is larger than that of the ventilation pipe is known.

For example, described in JP1995-229415 (JP-H07-229415) is an expansion type silencer in which gas flow pipes are attached to both of front and rear ends of a cylindrical container, a sound absorbing material is attached to an inner surface of a side wall of the container, the radial thickness of the sound absorbing material gradually changes in an axial direction, and an inner surface of the sound absorbing material is a tapered surface.

### SUMMARY OF THE INVENTION

An air passage type silencer is used for noise reduction in a blower, a fan, or the like. In general, an expansion type silencer reflects a sound for sound attenuation. However, there is a demand for a silencer that attenuates a sound by absorbing the sound instead of reflecting the sound as an air passage type silencer.

In a case where a reflective type silencer is used, a sound reflected by the silencer interferes with an incidence sound. Therefore, sound pressure distribution ahead of an inlet of the silencer is sparse/dense distribution and a sound pressure amplitude is large at the position where sound pressure distribution is dense. There is a problem that a noise is likely to be radiated to the outside since a sound with such large distribution excites vibration (vibration of a hose, a duct, and the like) of a housing present ahead of the silencer. In addition, there is also a case where a reflected sound returns by being reflected again, which causes a further increase in sound pressure. Therefore, there is a demand for an air passage type silencer that attenuates a sound by absorbing the sound instead of reflecting the sound.

In addition, the expansion type silencer has a problem that a wind noise is generated in a case where wind flows into an expansion chamber.

In addition, in the case of the expansion type silencer, there is a frequency (a frequency at which there is no sound attenuation effect) at which strong resonance in a longitudinal direction occurs inside the expansion chamber due to strong reflection at an inlet of the expansion chamber and transmission occurs resonantly. Particularly, it is difficult to take measures against transmission resonance occurring on a low frequency side.

An object of the present invention is to provide an air passage type silencer and an acoustic impedance change structure of which the absorbance is high, that suppresses generation of a wind noise, and that has a high sound attenuation effect in a low-frequency band while solving the above-described problem of the related art.

In order to solve the above-described problem, the present invention has the following configurations.

[1] An acoustic impedance change structure through which a sound propagates, the acoustic impedance change structure including at least in this order:
a first impedance matching region that is connected to an inlet portion and in which an acoustic impedance gradually decreases;
an acoustic impedance constancy region; and
an outlet portion,
in which Z_{cham}<Zᵢₙ and Z_{cham}<Zₒᵤₜ are satisfied, where Zᵢₙ is an acoustic impedance in the inlet portion, Z_{cham} is an acoustic impedance in the acoustic impedance constancy region, and Zₒᵤₜ is an acoustic impedance in the outlet portion, and
a first terminal structure acoustically connected to the acoustic impedance constancy region is provided.

[2] The acoustic impedance change structure described in [1],
in which the first terminal structure is acoustically connected to the acoustic impedance constancy region and the first impedance matching region.

[3] The acoustic impedance change structure described in [1] or [2], further including:
a second impedance matching region that is disposed between the acoustic impedance constancy region and the outlet portion, that is connected to the outlet portion, and in which an acoustic impedance gradually increases; and
a second terminal structure that is connected to the acoustic impedance constancy region.

[4] An air passage type silencer including:
an inlet-side ventilation pipe;
an expansion portion that communicates with the inlet-side ventilation pipe and of which a cross-sectional area is larger than a cross-sectional area of the inlet-side ventilation pipe;
an outlet-side ventilation pipe that communicates with the expansion portion and of which a cross-sectional area is smaller than a cross-sectional area of the expansion portion;
a first opening portion structure in which an acoustic impedance gradually decreases from a connection portion between the expansion portion and the inlet-side ventilation pipe toward an outlet-side ventilation pipe side; and
a first rear surface space that is surrounded by the first opening portion structure, a side surface of the expansion portion that is on an inlet-side ventilation pipe side, and a peripheral surface of the expansion portion and that is open on the outlet-side ventilation pipe side of the expansion portion.

[5] The air passage type silencer described in [4],
in which a cutoff frequency fc of the first opening portion structure, which is determined by a shape of the first opening portion structure, is 2000 Hz or less.

[6] The air passage type silencer described in [4] or [5],
in which 0.2≤a/L≤0.8, where L is a length of the expansion portion and a is a length of the first opening portion structure in a flow path direction of a sound wave in the air passage type silencer.

[7] The air passage type silencer described in any one of [4] to [6], further including:
a second opening portion structure of which a cross-sectional area gradually decreases from an inside of the expansion portion toward a connection portion between the expansion portion and the outlet-side ventilation pipe; and
a second rear surface space that is surrounded by the second opening portion structure, a side surface of the expansion portion that is on the outlet-side ventilation pipe side, and the peripheral surface of the expansion portion and that is open on the inlet-side ventilation pipe side of the expansion portion.

[8] The air passage type silencer described in [7],
in which a cutoff frequency fc of the second opening portion structure, which is determined by a shape of the second opening portion structure, is 2000 Hz or less.

[9] The air passage type silencer described in [7] or [8],
in which 0.2≤a₂/L≤0.8, where L is a length of the expansion portion and a₂ is a sum of lengths of the first opening portion structure and the second opening portion structure in a flow path direction of a sound wave in the air passage type silencer.

[10] The air passage type silencer described in any one of [4] to [9],
in which a ratio between an acoustic impedance in an inlet portion of the rear surface space and a minimum acoustic impedance in the rear surface space is 1.1 or more.

[11] The air passage type silencer described in any one of [4] to [10],
in which a sound absorption structure is provided in at least a portion of the expansion portion.

[12] The air passage type silencer described in [11],
in which the sound absorption structure is a porous sound absorbing material.

[13] The air passage type silencer described in [11] or [12],
in which at least a portion of the sound absorption structure is disposed along a housing of the expansion portion.

[14] The air passage type silencer described in any one of [11] to [13],
in which the sound absorption structure is in contact with a maximum diameter portion of at least one of the first opening portion structure or the second opening portion structure.

[15] The air passage type silencer described in any one of [11] to [13],
in which the sound absorption structure is disposed between the first opening portion structure and the second opening portion structure, and
the sound absorption structure is not disposed in at least one of the first rear surface space or the second rear surface space.

[16] The air passage type silencer described in any one of [4] to [15],
in which a change in acoustic impedance in at least one of the first opening portion structure or the second opening portion structure continues to an outside of the expansion portion.

[17] The air passage type silencer described in any one of [4] to [16],
in which an average roughness Ra of an inner surface of at least one of the first opening portion structure or the second opening portion structure is 1 mm or less.

[18] The air passage type silencer described in any one of [4] to [17],
in which a cross-sectional shape of the expansion portion is circular or rectangular.

[19] The air passage type silencer described in any one of [4] to [17],
in which the first opening portion structure is not closed in a cross section at an end portion on the outlet-side ventilation pipe side.

[20] The air passage type silencer described in any one of [7] to [19],
in which the second opening portion structure is not closed in a cross section at an end portion on the inlet-side ventilation pipe side.

[21] The air passage type silencer described in any one of [4] to [20],
in which the first opening portion structure includes a region in which a wall thickness decreases toward the outlet-side ventilation pipe side.

[22] The air passage type silencer described in any one of [7] to [21],
in which the second opening portion structure includes a region in which a wall thickness decreases toward the inlet-side ventilation pipe side.

[23] The air passage type silencer described in any one of [7] to [22],
in which a position of connection to the first opening portion structure and a position of connection to the second opening portion structure at side surfaces of the expansion portion are positioned at centers of the side surfaces.

[24] The air passage type silencer described in any one of [7] to [23],
in which shapes of the first opening portion structure and the second opening portion structure have two-fold or greater-fold symmetry.

[25] The air passage type silencer described in any one of [7] to [24],
in which a length of the first opening portion structure is larger than a length of the second opening portion structure in a flow path direction.

According to the present invention it is possible to provide an air passage type silencer and an acoustic impedance change structure of which the absorbance is high, that suppresses generation of a wind noise, and that has a high sound attenuation effect in a low-frequency band.

### BRIEF DESCRIPTION OF THE DRAWINGS

FIG. 1 is a block diagram schematically showing an example of an acoustic impedance change structure according to an aspect of the present invention.

FIG. 2 is a block diagram schematically showing another example of the acoustic impedance change structure according to the aspect of the present invention.

FIG. 3 is a cross-sectional view conceptually showing an example of an air passage type silencer according to the aspect of the present invention.

FIG. 4 is a conceptual view for description of a correspondence relationship between the air passage type silencer and the acoustic impedance change structure according to the aspect of the present invention.

FIG. 5 is a cross-sectional view conceptually showing another example of the air passage type silencer according to the aspect of the present invention.

FIG. 6 is a conceptual view for description of a relationship between the length of an expansion portion and the length of an opening portion structure.

FIG. 7 is a cross-sectional view conceptually showing an example of the opening portion structure.

FIG. 8 is a cross-sectional view conceptually showing another example of the opening portion structure.

FIG. 9 is a cross-sectional view conceptually showing another example of the opening portion structure.

FIG. 10 is a perspective view conceptually showing another example of the opening portion structure.

FIG. 11 is a perspective view conceptually showing another example of the opening portion structure.

FIG. 12 is a perspective view conceptually showing another example of the opening portion structure.

FIG. 13 is a conceptual view for description of the shape of another example of the air passage type silencer.

FIG. 14 is a graph showing a relationship between a frequency and an absorbance.

FIG. 15 is a graph showing a relationship between the length of the opening portion structure and the average of absorbances.

FIG. 16 is a graph showing a relationship between the length of the opening portion structure and the average of absorbances.

FIG. 17 is a graph showing a relationship between the length of the opening portion structure and the average of absorbances.

FIG. 18 is a graph showing a relationship between the length of the opening portion structure and the average of absorbances.

FIG. 19 is a graph showing a relationship between the frequency and transmission loss.

FIG. 20 is a graph showing a relationship between the maximum diameter of the opening portion structure and a frequency at which transmission loss is largest.

FIG. 21 is a graph showing a relationship between an impedance ratio and a frequency ratio.

FIG. 22 is a graph showing a relationship between the length of the opening portion structure and a maximum sound insulation frequency.

FIG. 23 is a graph showing a relationship between the frequency and the transmission loss.

FIG. 24 is a graph showing a relationship between the frequency and the transmission loss.

FIG. 25 is a graph showing a relationship between the frequency and the transmission loss.

FIG. 26 is a graph showing a relationship between the frequency and the transmission loss.

FIG. 27 is a graph showing a relationship between the frequency and the absorbance.

FIG. 28 is a graph showing a relationship between the frequency and the transmission loss.

FIG. 29 is a graph showing a relationship between the frequency and the absorbance.

FIG. 30 is a graph showing a relationship between the frequency and the absorbance.

FIG. 31 is a graph showing a relationship between the frequency and the transmission loss.

FIG. 32 is a graph showing a relationship between the frequency and the absorbance.

FIG. 33 is a graph showing a relationship between the length of the opening portion structure and a calculated vortex degree value.

FIG. 34 is a graph showing a relationship between the length of the opening portion structure and the calculated vortex degree value.

FIG. 35 is a view for description of the shape of an opening portion structure in a comparative example.

FIG. 36 is a graph showing a relationship between a position and a hole area ratio.

FIG. 37 is a graph showing a relationship between the position and an estimated impedance value.

FIG. 38 is a graph showing a relationship between the frequency and the absorbance.

FIG. 39 is a graph showing a relationship between the frequency and the absorbance.

FIG. 40 is a cross-sectional view conceptually showing another example of the air passage type silencer according to the aspect of the present invention.

FIG. 41 is a cross-sectional view conceptually showing another example of the air passage type silencer according to the aspect of the present invention.

FIG. 42 is a cross-sectional view conceptually showing another example of the air passage type silencer according to the aspect of the present invention.

FIG. 43 is a cross-sectional view conceptually showing another example of the air passage type silencer according to the aspect of the present invention.

FIG. 44 is a cross-sectional view conceptually showing another example of the air passage type silencer according to the aspect of the present invention.

FIG. 45 is a cross-sectional view conceptually showing another example of the air passage type silencer according to the aspect of the present invention.

### DESCRIPTION OF THE PREFERRED EMBODIMENTS

Hereinafter, the present invention will be specifically described.

Although configuration requirements to be described below may be described based on a representative embodiment of the present invention, the present invention is not limited to such an embodiment.

Note that, in the present specification, a numerical range represented using “to” means a range including numerical values described before and after the preposition “to” as a lower limit value and an upper limit value.

In addition, in the present specification, “perpendicular” and “parallel” include a range of errors accepted in the technical field to which the present invention belongs. For example, “being perpendicular” or “being parallel” means being in a range of less than ±100 or the like with respect to being strictly perpendicular in the strict sense or being parallel in the strict sense and the error with respect to being strictly perpendicular in the strict sense or being parallel in the strict sense is preferably 5° or less, and more preferably 3° or less.

In the present specification, the meanings of “the same”, and “identical” may include a range of errors generally accepted in the technical field.

[Acoustic Impedance Change Structure]

An acoustic impedance change structure according to an aspect of the present invention is an acoustic impedance change structure through which a sound propagates, the acoustic impedance change structure including at least in this order:
a first impedance matching region that is connected to an inlet portion and in which the acoustic impedance gradually decreases;
an acoustic impedance constancy region; and
an outlet portion,
in which Z_{cham}<Zᵢₙ and Z_{cham}<Zₒᵤₜ are satisfied, where Zᵢₙ is the acoustic impedance in the inlet portion, Z_{cham} is the acoustic impedance in the acoustic impedance constancy region, and Zₒᵤₜ is the acoustic impedance in the outlet portion, and
a first terminal structure acoustically connected to the acoustic impedance constancy region is provided.

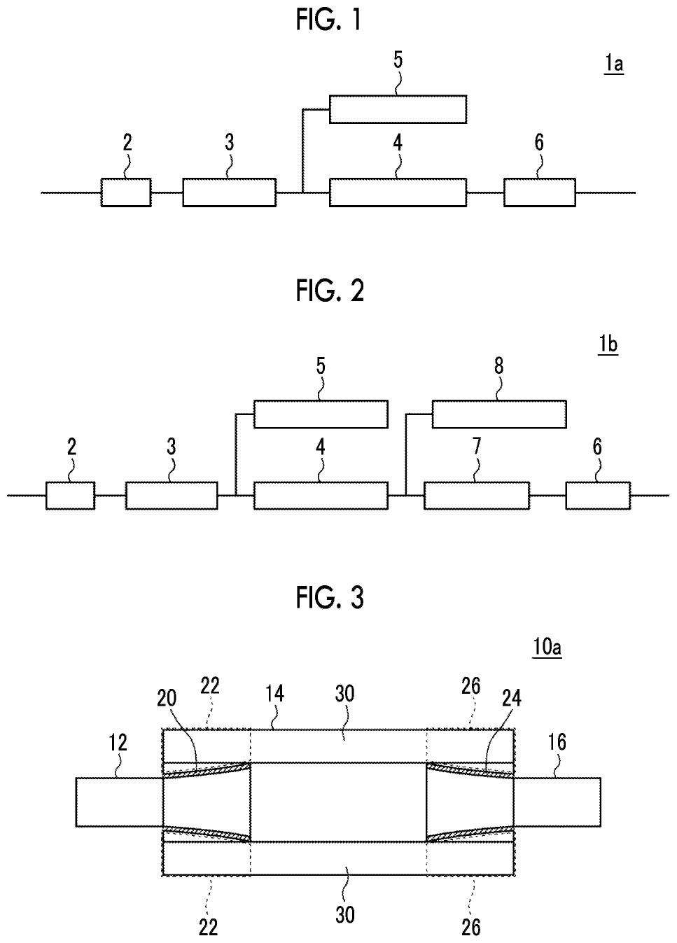

FIG. 1 is a block diagram schematically showing an example of the acoustic impedance change structure according to the aspect of the present invention.

An acoustic impedance change structure 1a shown in FIG. 1 is a structure through which a sound propagates and that includes an inlet portion 2, a first impedance matching region 3, an acoustic impedance constancy region 4, a first terminal structure 5, and an outlet portion 6. The inlet portion 2, the first impedance matching region 3, the acoustic impedance constancy region 4, and the outlet portion 6 are connected in this order, and the first terminal structure 5 is connected to the first impedance matching region 3 in parallel with the acoustic impedance constancy region 4. The acoustic impedance constancy region 4 and the first terminal structure 5 are acoustically connected to each other. That is, the first terminal structure 5 is acoustically connected to the acoustic impedance constancy region 4 and the first impedance matching region 3.

The acoustic impedance constancy region 4 is a region in which an acoustic impedance is approximately constant. The acoustic impedance constancy region satisfies Z_{cham}<Zᵢₙ and Z_{cham}<Zₒᵤₜ, where Zᵢₙ is the acoustic impedance in the inlet portion 2, Z_{cham} is the acoustic impedance in the acoustic impedance constancy region 4, and Zₒᵤₜ is the acoustic impedance in the outlet portion 6. That is, the acoustic impedances in the inlet portion 2 and the outlet portion 6 are larger than the acoustic impedance in the acoustic impedance constancy region 4.

Here, impedances in acoustics include a characteristic impedance Zs and an acoustic impedance ZA. The characteristic impedance Zs is an amount peculiar to a substance (a fluid) and is determined by a product of a density and a sound velocity. The acoustic impedance ZA is a ratio between a pressure to a flow rate for each position. In the case of a duct in which sound propagation can be regarded as a plane wave (“sound wavelength/2≥duct diameter” is standard), flow rate=cross-sectional area S×particle velocity, where S is the cross-sectional area of the duct at a corresponding position. Therefore, a relationship with respect to the characteristic impedance is established as “acoustic impedance ZA=1/S×Zs”. That is, in a case where the medium of a fluid stays the same (the characteristic impedance is constant), the acoustic impedance ZA is inversely proportional to a cross-sectional area. Even in a case where there is a duct expansion portion larger than “sound wavelength/2”, the above relationship equation is satisfied almost always in a case where incidence is plane wave incidence (in a case where the diameter of a ventilation pipe on an incidence side is about λ/2 or less).

The acoustic impedance in the present invention is ZA described above. That is, the acoustic impedance is an amount inversely proportional to the cross-sectional area of a plane perpendicular to a flow path direction at each position.

In addition, the first impedance matching region 3 has a configuration in which the acoustic impedance gradually decreases.

That is, the acoustic impedance change structure 1a includes the acoustic impedance constancy region 4 that is provided between the inlet portion 2 and the outlet portion 6 and in which the acoustic impedance is smaller than the acoustic impedances in the inlet portion 2 and the outlet portion 6, and has a configuration in which the inlet portion 2 and the acoustic impedance constancy region 4 are connected to each other by the first impedance matching region 3 in which the acoustic impedance gradually decreases.

In such an acoustic impedance change structure 1a, a sound intrudes through the inlet portion 2, passes through the first impedance matching region 3, intrudes into the acoustic impedance constancy region 4, and passes through the acoustic impedance constancy region 4, and reaches the outlet portion 6 while a portion thereof enters the first terminal structure 5 and returns due to reflection.

Here, it is preferable that the acoustic impedance change structure includes a second impedance matching region 7 that is disposed between the acoustic impedance constancy region 4 and the outlet portion 6, that is connected to the outlet portion 6, and in which the acoustic impedance gradually increases and a second terminal structure 8 that is connected to the acoustic impedance constancy region 4 in parallel. The acoustic impedance constancy region 4 and the second terminal structure 8 are acoustically connected.

FIG. 2 is a block diagram schematically showing another example of the acoustic impedance change structure according to the aspect of the present invention.

An acoustic impedance change structure 1b shown in FIG. 2 includes the inlet portion 2, the first impedance matching region 3, the acoustic impedance constancy region 4, the first terminal structure 5, the second impedance matching region 7, the second terminal structure 8, and the outlet portion 6. The inlet portion 2, the first impedance matching region 3, the acoustic impedance constancy region 4, the second impedance matching region 7, and the outlet portion 6 are connected in this order, the first terminal structure 5 is connected to the first impedance matching region 3 in parallel with the acoustic impedance constancy region 4, and the second terminal structure 8 is connected to the second impedance matching region 7 in parallel with an acoustic impedance reduction portion.

The second impedance matching region 7 has a configuration in which the acoustic impedance gradually increases.

That is, the acoustic impedance change structure 1b includes the acoustic impedance constancy region 4 that is provided between the inlet portion 2 and the outlet portion 6 and in which the acoustic impedance is smaller than the acoustic impedances in the inlet portion 2 and the outlet portion 6, and has a configuration in which the inlet portion 2 and the acoustic impedance constancy region 4 are connected to each other by the first impedance matching region 3 in which the acoustic impedance gradually decreases and the acoustic impedance constancy region 4 and the outlet portion 6 are connected to each other by the second impedance matching region 7 in which the acoustic impedance gradually increases.

In such an acoustic impedance change structure 1b, a sound intrudes through the inlet portion 2, passes through the first impedance matching region 3, intrudes into the acoustic impedance constancy region 4, and passes through the second impedance matching region 7 from the acoustic impedance constancy region 4, and reaches the outlet portion 6 while a portion thereof enters the first terminal structure 5 and returns due to reflection and another portion thereof enters the second terminal structure 8 and returns due to reflection.

The action of such an acoustic impedance change structure will be described with the action of an air passage type silencer as follows.

[Air Passage Type Silencer]

An air passage type silencer according to an aspect of the present invention is an air passage type silencer including
an inlet-side ventilation pipe,
an expansion portion that communicates with the inlet-side ventilation pipe and of which the cross-sectional area is larger than the cross-sectional area of the inlet-side ventilation pipe,
an outlet-side ventilation pipe that communicates with the expansion portion and of which the cross-sectional area is smaller than the cross-sectional area of the expansion portion,
a first opening portion structure in which the acoustic impedance gradually decreases from a connection portion between the expansion portion and the inlet-side ventilation pipe toward the outlet-side ventilation pipe, and
a first rear surface space that is surrounded by the first opening portion structure, a side surface of the expansion portion that is on an inlet-side ventilation pipe side, and a peripheral surface of the expansion portion and that is open on the outlet-side ventilation pipe side of the expansion portion.

The configuration of the air passage type silencer according to the aspect of the present invention will be described with reference to the drawings.

FIG. 3 is a schematic cross-sectional view showing an example of an embodiment of the air passage type silencer according to the aspect of the present invention.

As shown in FIG. 3, an air passage type silencer 10 includes a tubular inlet-side ventilation pipe 12, an expansion portion 14 connected to one opening edge surface of the inlet-side ventilation pipe 12, a tubular outlet-side ventilation pipe 16 that is connected to an edge surface of the expansion portion 14 on a side opposite to the inlet-side ventilation pipe 12, a first opening portion structure 20, a second opening portion structure 24, and a porous sound absorbing material 30.

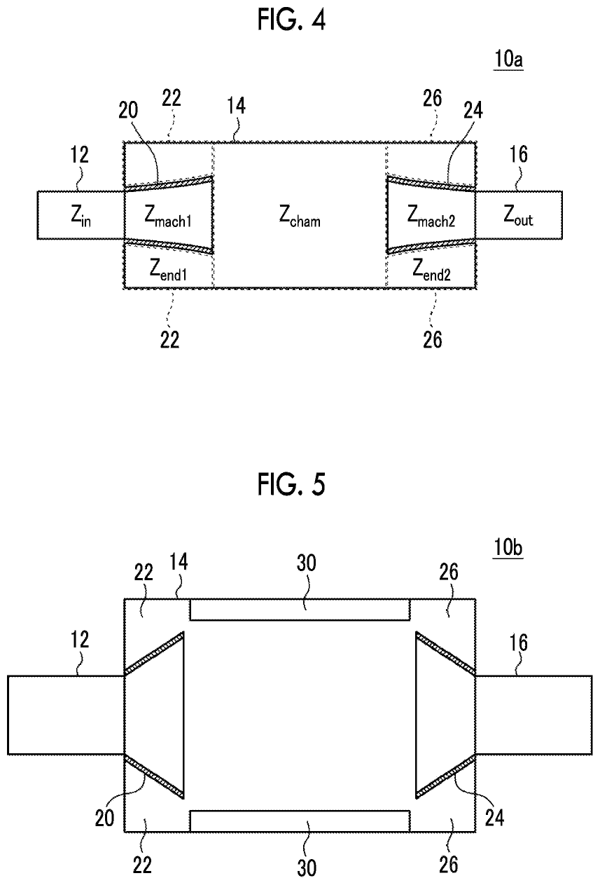

As shown in FIG. 4, the inlet-side ventilation pipe 12 corresponds to the inlet portion 2 (represented by Zᵢₙ in FIG. 4) of the above-described acoustic impedance change structure, a region in the expansion portion 14 that is between the first opening portion structure 20 and the second opening portion structure 24 corresponds to the acoustic impedance constancy region 4 (represented by Z_{cham} in FIG. 4), the outlet-side ventilation pipe 16 corresponds to the outlet portion 6 (represented by Zₒᵤₜ in FIG. 4), the first opening portion structure 20 corresponds to the first impedance matching region 3 (represented by Z_{mach1} in FIG. 4), and the second opening portion structure 24 corresponds to the second impedance matching region 7 (represented by Z_{mach2} in FIG. 4). Note that the porous sound absorbing material is not shown in FIG. 4.

The inlet-side ventilation pipe 12 is a tubular member through which a gas that flows into the inlet-side ventilation pipe 12 through one opening edge surface is transported to the expansion portion 14 connected to the other opening edge surface.

The outlet-side ventilation pipe 16 is a tubular member through which a gas that flows into the outlet-side ventilation pipe 16 through one opening edge surface connected to the expansion portion 14 is transported to the other opening edge surface.

The cross-sectional shapes of the inlet-side ventilation pipe 12 and the outlet-side ventilation pipe 16 (hereinafter, collectively referred to as ventilation pipes) may be various shapes such as a circular shape, a rectangular shape, and a triangular shape. In addition, the cross-sectional shape of a ventilation pipe may not be constant in an axial direction along a central axis of the ventilation pipe. For example, the diameter of the ventilation pipe may change in the axial direction.

The inlet-side ventilation pipe 12 and the outlet-side ventilation pipe 16 may have the same cross-sectional shape and cross-sectional area, or may have different shapes and/or cross-sectional areas. In addition, in an example shown in FIG. 3, the inlet-side ventilation pipe 12 and the outlet-side ventilation pipe 16 are disposed such that central axes thereof coincide with each other. However, the present invention is not limited thereto and the central axis of the inlet-side ventilation pipe 12 and the central axis of the outlet-side ventilation pipe 16 may be offset from each other.

In the following description, a direction in which the inlet-side ventilation pipe 12, the expansion portion 14, and the outlet-side ventilation pipe 16 are arranged will be referred to as a flow path direction in some cases.

The expansion portion 14 is disposed between the inlet-side ventilation pipe 12 and the outlet-side ventilation pipe 16 and transports, to the outlet-side ventilation pipe 16, a gas that flows into the expansion portion 14 from the inlet-side ventilation pipe 12.

The area of a cross section of the expansion portion 14 that is perpendicular to the flow path direction is larger than the cross-sectional area of the inlet-side ventilation pipe 12 and is larger than the cross-sectional area of the outlet-side ventilation pipe 16. That is, for example, in a case where the cross-sectional shapes of the inlet-side ventilation pipe 12, the outlet-side ventilation pipe 16, and the expansion portion 14 are circular, the diameter of the cross-section of the expansion portion 14 is larger than the diameters of the inlet-side ventilation pipe 12 and the outlet-side ventilation pipe 16.

The cross-sectional shape of the expansion portion 14 may be various shapes such as a circular shape, a rectangular shape, and a triangular shape. In addition, the cross-sectional shape of the expansion portion 14 may not be constant in an axial direction along a central axis of the expansion portion 14. For example, the diameter of the expansion portion 14 may change in the axial direction.

The first opening portion structure 20 is disposed at the position of connection between the expansion portion 14 and the inlet-side ventilation pipe 12 and the second opening portion structure 24 is disposed at the position of connection between the expansion portion 14 and the outlet-side ventilation pipe 16. In addition, the porous sound absorbing material 30 is disposed along an inner peripheral surface of the expansion portion 14.

The porous sound absorbing material 30 is a kind of sound absorption structure according to an aspect of the present invention, and is disposed in the expansion portion 14 to absorb and attenuate a sound. In the example shown in the drawing, the porous sound absorbing material 30 is disposed along the inner peripheral surface of the expansion portion 14. In addition, in the example shown in the drawing, the length of the porous sound absorbing material 30 in the flow path direction approximately coincides with the length of the expansion portion 14 in the flow path direction. In addition, it is preferable that the porous sound absorbing material 30 has such a thickness in a direction perpendicular to the flow path direction that the porous sound absorbing material 30 does not overlap with the ventilation pipes as seen in the flow path direction. In the example shown in the drawing, the porous sound absorbing material 30 has such a thickness that the porous sound absorbing material 30 comes into contact with a maximum diameter portion of the first opening portion structure 20 and a maximum diameter portion of the second opening portion structure 24.

For example, in a case where the expansion portion 14 has a cylindrical shape, the porous sound absorbing material 30 may have a cylindrical shape matching the shape of a peripheral surface of the expansion portion 14. In addition, in a case where the expansion portion 14 has a quadrangular tube-like shape, the porous sound absorbing material 30 may have a quadrangular tube-like shape matching the shape of the peripheral surface of the expansion portion 14.

The first opening portion structure 20 is disposed to be in contact with a connection portion with respect to the inlet-side ventilation pipe 12 in the expansion portion 14 and has a configuration in which the acoustic impedance gradually decreases from the inlet-side ventilation pipe 12 toward the outlet-side ventilation pipe 16. In the example shown in FIG. 3, the first opening portion structure 20 has a tubular shape of which the opening area gradually increases from an end portion of the inlet-side ventilation pipe 12 toward an end portion on the outlet-side ventilation pipe 16 side so that the acoustic impedance gradually decreases.

In the example shown in the drawing, the shape and the area of an opening of the first opening portion structure 20 that is on the inlet-side ventilation pipe 12 side approximately coincide with the cross-sectional shape and the cross-sectional area of the inlet-side ventilation pipe 12. In addition, an edge surface of the first opening portion structure 20 that is on the outlet-side ventilation pipe 16 side does not come into contact with the peripheral surface of the expansion portion 14. In the example shown in the drawing, the edge surface of the first opening portion structure 20 that is on the outlet-side ventilation pipe 16 side is in contact with the porous sound absorbing material 30 disposed along an inner side of the peripheral surface of the expansion portion 14.

Since the first opening portion structure 20 does not come into contact with the peripheral surface of the expansion portion 14, a first rear surface space 22 is formed between the first opening portion structure 20 and the expansion portion 14. Specifically, the first rear surface space 22 is a space surrounded by the first opening portion structure 20, a side surface of the expansion portion 14 that is on the inlet-side ventilation pipe 12 side, and the peripheral surface of the expansion portion 14 like a region represented by a broken line in FIG. 3. The first rear surface space 22 is open on the outlet-side ventilation pipe 16 side. As shown in FIG. 4, the first rear surface space 22 corresponds to the first terminal structure 5 (represented by Z_{end1} in FIG. 4).

The second opening portion structure 24 is disposed to be in contact with a connection portion with respect to the outlet-side ventilation pipe 16 in the expansion portion 14 and has a configuration in which the acoustic impedance gradually increases from the inlet-side ventilation pipe 12 toward the outlet-side ventilation pipe 16. In the example shown in FIG. 3, the second opening portion structure 24 has a tubular shape of which the opening area gradually decreases from the end portion of the inlet-side ventilation pipe 12 toward the end portion on the outlet-side ventilation pipe 16 side so that the acoustic impedance gradually increases.

In the example shown in the drawing, the shape and the area of an opening of the second opening portion structure 24 that is on the outlet-side ventilation pipe 16 side approximately coincide with the cross-sectional shape and the cross-sectional area of the outlet-side ventilation pipe 16. In addition, an edge surface of the second opening portion structure 24 that is on the inlet-side ventilation pipe 12 side does not come into contact with the peripheral surface of the expansion portion 14. In the example shown in the drawing, the edge surface of the second opening portion structure 24 that is on the inlet-side ventilation pipe 12 side is in contact with the porous sound absorbing material 30 disposed along an inner side of the peripheral surface of the expansion portion 14.

Since the second opening portion structure 24 does not come into contact with the peripheral surface of the expansion portion 14, a second rear surface space 26 is formed between the second opening portion structure 24 and the expansion portion 14. Specifically, the second rear surface space 26 is a space surrounded by the second opening portion structure 24, a side surface of the expansion portion 14 that is on the outlet-side ventilation pipe 16 side, and the peripheral surface of the expansion portion 14 like a region represented by a broken line in FIG. 3. The second rear surface space 26 is open on the inlet-side ventilation pipe 12 side. As shown in FIG. 4, the second rear surface space 26 corresponds to the second terminal structure 8 (represented by Z_{end2} in FIG. 4).

As described above, a silencer including an expansion chamber reflects a sound for sound attenuation. In a case where a reflective type silencer is used, a sound reflected by the silencer interferes with an incidence sound. Therefore, sound pressure distribution ahead of an inlet of the silencer is sparse/dense distribution with a sound pressure amplitude being large.

There is a problem that a noise is likely to be radiated to the outside since a sound with such large distribution excites vibration (vibration of a hose, a duct, and the like) of a housing present ahead of the silencer. In addition, there is also a case where a reflected sound returns by being reflected again, which causes a further increase in sound pressure. Therefore, there is a demand for an air passage type silencer that attenuates a sound by absorbing the sound instead of reflecting the sound.

In addition, the expansion type silencer has a problem that a wind noise is generated in a case where wind flows into an expansion chamber.

In addition, in the case of the expansion type silencer, there is a frequency (a frequency at which there is no sound attenuation effect) at which strong resonance in a longitudinal direction occurs inside the expansion chamber due to strong reflection at an inlet of the expansion chamber and transmission occurs resonantly. Particularly, it is difficult to take measures against transmission resonance occurring on a low frequency side.

However, since the air passage type silencer according to the aspect of the present invention includes the first opening portion structure 20 in which the acoustic impedance gradually decreases from a connection portion between the expansion portion 14 and the inlet-side ventilation pipe 12 toward the outlet-side ventilation pipe 16, it is possible to suppress reflection in the case of propagation of a sound from the inlet-side ventilation pipe 12 to the expansion portion 14 and to increase the amount of a sound propagating into the expansion portion 14. Therefore, it is possible to increase the amount of a sound absorbed by a sound absorption structure (the porous sound absorbing material) disposed in the expansion portion 14, and it is possible to suitably perform sound attenuation by means of sound absorption.

In addition, a wind noise is a phenomenon that occurs because a vortex is generated at a position where the acoustic impedance changes steeply. However, since the air passage type silencer according to the aspect of the present invention includes the first opening portion structure 20 in which the acoustic impedance gradually decreases, it is possible to suppress generation of a vortex in the case of propagation of a sound from the inlet-side ventilation pipe 12 to the expansion portion 14 and to prevent generation of a wind noise sound.

In addition, in the air passage type silencer according to the aspect of the present invention, the first rear surface space 22 is formed between the first opening portion structure 20 and the expansion portion 14. The first rear surface space 22 acts as a resonator of which the resonance frequency is made lower than that of a general air-column resonator (the action of a Helmholtz resonator is mixed) since the size of an opening portion communicating with the expansion portion 14 is made small by the first opening portion structure, so that a sound in a low-frequency band can be attenuated.

In addition, it is preferable that an air passage type silencer 10a shown in FIG. 3 includes the second opening portion structure 24 in which the acoustic impedance gradually increases from the inside of the expansion portion 14 toward a connection portion between the expansion portion 14 and the outlet-side ventilation pipe 16. Since the second opening portion structure 24 is provided, it is possible to suppress excitation of vibration of a housing and to suppress a further increase in sound pressure caused in a case where a reflected sound returns by being reflected again.

In addition, since the air passage type silencer 10a includes the second opening portion structure 24, it is possible to suppress reflection in the case of propagation of a sound from the expansion portion 14 to the outlet-side ventilation pipe 16, to suppress generation of a vortex, and to prevent generation of a wind noise.

In addition, in the air passage type silencer 10a, the second rear surface space 26 is formed between the second opening portion structure 24 and the expansion portion 14 and the second rear surface space 26 acts as a resonator of which the resonance frequency is made lower than that of a general air-column resonator (the action of a Helmholtz resonator is mixed) since the size of an opening portion communicating with the expansion portion 14 is made small, so that a sound in a low-frequency band can be attenuated.

Note that the first opening portion structure 20 and the second opening portion structure 24 basically have the same configuration except that positions at which the opening portion structures are disposed and the orientations thereof are different from each other.

Therefore, in the following description, the first opening portion structure 20 and the second opening portion structure 24 will be collectively referred to as the “opening portion structures” in a case where it is not necessary to distinguish the first opening portion structure 20 and the second opening portion structure 24 from each other.

Note that, in the example shown in FIG. 3, the air passage type silencer 10a is configured to include the second opening portion structure 24. However, the present invention is not limited thereto as long as the air passage type silencer 10a includes the first opening portion structure 20 at least.

In addition, in the example shown in FIG. 3, the porous sound absorbing material 30 is disposed over the entire expansion portion 14 in the flow path direction, that is, the porous sound absorbing material 30 is disposed in the first rear surface space 22 and the second rear surface space 26 as well. However, the present invention is not limited thereto. For example, as in the case of an air passage type silencer 10b shown in FIG. 5, the porous sound absorbing material 30 may be disposed between the first opening portion structure 20 and the second opening portion structure 24 with the porous sound absorbing material 30 being not disposed in at least one of the first rear surface space 22 or the second rear surface space 26.

In the case of a configuration in which the porous sound absorbing material 30 is disposed in the first rear surface space 22 and the second rear surface space 26, the amount of sound absorption can be made larger. Meanwhile, in the case of a configuration in which the porous sound absorbing material 30 is not disposed in at least one of the first rear surface space 22 and the second rear surface space 26, it is possible to suitably attenuate a sound in a low-frequency band by using the action of the rear surface spaces as the Helmholtz resonator.

In addition, the porous sound absorbing material does not need to be disposed on the all of the surfaces of the expansion portion 14 and for example, a configuration in which porous sound absorbing materials are disposed on two opposite surfaces of a rectangular expansion portion without being disposed on the other two surfaces may also be adopted. Accordingly, porous sound absorbing materials on two surfaces are not necessary and thus reduction in thickness of an air passage type silencer can be realized. In addition, a configuration in which the thicknesses of porous sound absorbing materials change depending on the place and, for example, the porous sound absorbing materials disposed on the two opposite surfaces are thin porous sound absorbing materials may also be adopted.

In addition, as shown in FIG. 40, a configuration in which the porous sound absorbing material 30 is disposed to be in contact with the first opening portion structure 20 and the second opening portion structure 24 in the expansion portion 14 of which the cross-sectional shape is rectangular and a space 14a is formed on a rear surface side (a side opposite to the first opening portion structure 20 and the second opening portion structure 24) of the porous sound absorbing material 30 may also be adopted. In the case of such a configuration, since it is difficult for wind flowing through the air passage type silencer to pass through the porous sound absorbing material 30, the flow path of the wind leads from the first opening portion structure 20 to the porous sound absorbing material 30 and the second opening portion structure 24 smoothly, so that a wind noise is less likely to be generated. With this configuration, the amount of use of the porous sound absorbing material 30 can be reduced in comparison a case where the porous sound absorbing material 30 is disposed throughout the expansion portion 14.

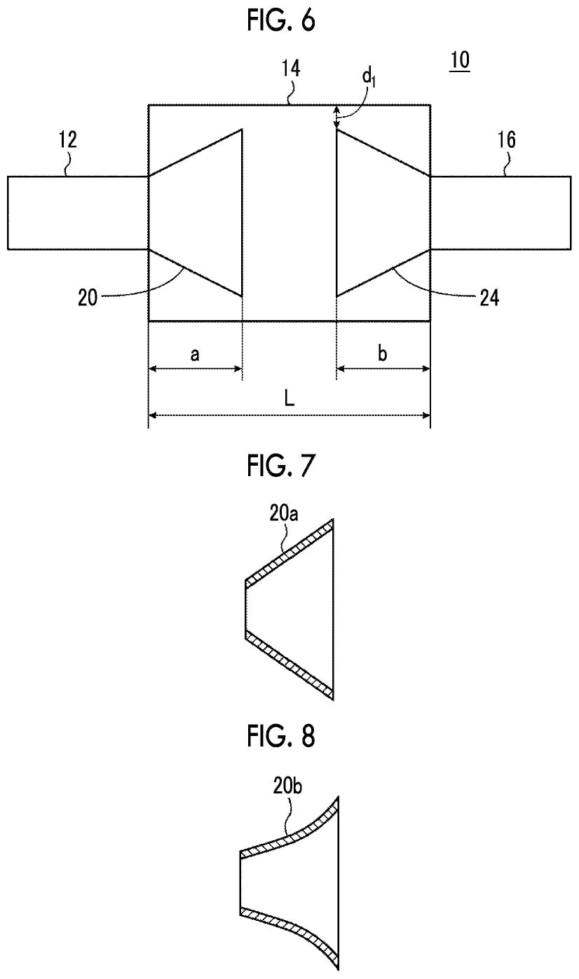

In addition, in the case of a configuration in which the air passage type silencer includes the first opening portion structure 20 and the second opening portion structure 24, it is preferable that 0.2≤a₂/L≤0.8, it is more preferable that 0.3≤a₂/L≤0.7, and it is still more preferable that 0.4≤a₂/L≤0.6, where a is the length of the first opening portion structure 20 in the flow path direction, b is the length of the second opening portion structure 24 in the flow path direction, L is the length of the expansion portion 14 in the flow path direction (refer to FIG. 6), and a₂ is the sum of the length a of the first opening portion structure 20 in the flow path direction and the length b of the second opening portion structure 24 in the flow path direction.

In addition, in the case of a configuration in which the air passage type silencer includes the first opening portion structure 20 and does not include the second opening portion structure 24, the length a of the first opening portion structure 20 in the flow path direction and the length L of the expansion portion 14 in the flow path direction preferably satisfy 0.2≤a/L≤0.8, more preferably satisfy 0.25≤a/L≤0.65, and still more preferably satisfy 0.3≤a/L≤0.5.

In a case where a ratio of the sum of the lengths of the opening portion structures (or the length of the first opening portion structure) to the length of the expansion portion 14 is large, reflection of a sound propagating from the inlet-side ventilation pipe 12 to the expansion portion 14 or reflection of a sound propagating from the expansion portion 14 to the outlet-side ventilation pipe 16 can be suppressed more suitably. Meanwhile, in a case where a ratio of the sum of the lengths of the opening portion structures (or the length of the first opening portion structure) to the length of the expansion portion 14 is small, the area of contact between a sound and the porous sound absorbing material 30 is increased and thus a sound absorption effect can be enhanced.

In addition, it is preferable that the length a of the first opening portion structure 20 is larger than the length b of the second opening portion structure 24. In a case where the length of the first opening portion structure 20 is large, it is possible to enhance the sound absorption effect with an increase in area of contact between a sound and the porous sound absorbing material 30 while suitably preventing reflection of a sound propagating from the inlet-side ventilation pipe 12 to the expansion portion 14.

Here, the shapes of the opening portion structures are not particularly limited as long as the acoustic impedance gradually changes therein. Examples of the opening portion structures will be described with reference to FIGS. 7 to 12.

An opening portion structure 20a shown in FIG. 7 has a conical tube-like shape and includes an opening penetrating the opening portion structure in a direction from an upper base to a lower base.

An opening portion structure 20b shown in FIG. 8 has a shape obtained by rotating a curve convex toward a central axis around the central axis. It also can be said that FIG. 8 is a shape obtained by curving a peripheral surface of a conical tube-like shape as shown in FIG. 7 to be convex toward a central axis. The shape of a peripheral surface of the opening portion structure 20b can be curved in various ways as long as the cross-sectional area thereof gradually increases along the central axis. For example, as seen in a cross section parallel to the central axis, the peripheral surface of the opening portion structure 20b may have a shape represented by an exponential function. Alternatively, as seen in a cross section parallel to the central axis, the peripheral surface of the opening portion structure 20b may have a shape represented by ¼ of an arc of an oval.

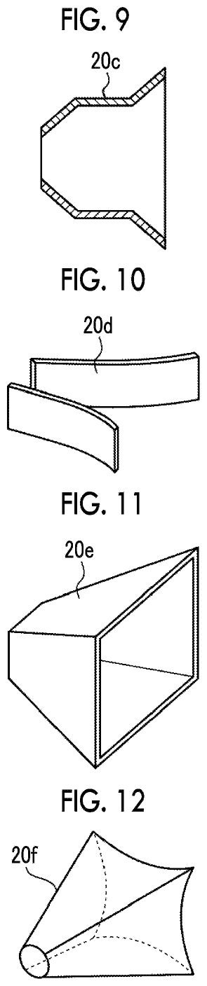

An opening portion structure 20c shown in FIG. 9 has a shape including a portion of which the diameter monotonically increases along an central axis, a portion of which the diameter is constant, and a portion of which the diameter monotonically increases. That is, in the opening portion structure 20c, the acoustic impedance changes stepwise.

An opening portion structure 20d shown in FIG. 10 includes two curved plate-shaped members and the width of a space between the two plate-shaped members gradually increases from one end portion toward the other end portion. In addition, the opening portion structure 20d is open in a vertical direction in the drawing.

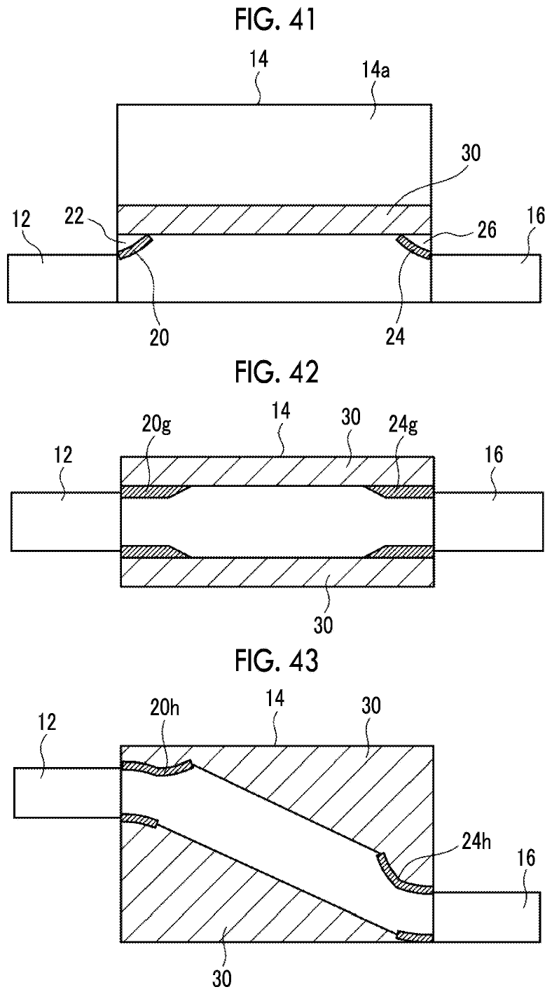

In addition, the opening portion structure may be only one of the plate-shaped members shown in FIG. 10. As shown in FIG. 41, an opening portion structure of which the size gradually increases can be realized by a configuration in which one side is a wall and the other side is a curved plate-shaped member.

As described above, the opening portion structure may be configured not to be closed in a cross section at an end portion on the other ventilation pipe side. That is, the first opening portion structure may be configured not to be closed in a cross section at an end portion on an outlet-side ventilation pipe side and the second opening portion structure may be configured not to be closed in a cross section at an end portion on an inlet-side ventilation pipe side.

An opening portion structure 20e shown in FIG. 11 has a rectangular cross-sectional shape and has a shape of which the cross-sectional area increases along a central axis while maintaining a similar shape. That is, the opening portion structure 20e shown has a quadrangular pyramid-like shape and includes an opening penetrating the opening portion structure in a direction from an upper base to a lower base.

An opening portion structure 20f shown in FIG. 12 has a shape obtained by causing each of four side surfaces of the opening portion structure 20e shown in FIG. 11 to protrude toward the central axis as seen in a cross section perpendicular to the central axis, and has a shape of which the cross-sectional area increases along the central axis while maintaining a similar shape.

In addition, the opening portion structure may not have a cross-sectional shape of which the size increases as in the above-described examples and a configuration in which the wall thickness of an end portion of the opening portion structure (20g, 24g) gradually decreases as in an example shown in FIG. 42 may also be adopted. That is, a first opening portion structure 20g has the same cross-sectional shape as the inlet-side ventilation pipe 12 and the wall thickness of an end portion on the outlet-side ventilation pipe 16 side gradually decreases toward the outlet-side ventilation pipe 16. In addition, a second opening portion structure 24g has the same cross-sectional shape as the outlet-side ventilation pipe 16, and the wall thickness of an end portion on the inlet-side ventilation pipe 12 side gradually decreases toward the inlet-side ventilation pipe 12. The first opening portion structure 20g and the inlet-side ventilation pipe 12 may be integrally formed with each other. In addition, the second opening portion structure 24g and the outlet-side ventilation pipe 16 may be integrally formed with each other.

For example, in a case where the inner diameter of the inlet-side ventilation pipe 12 and the outlet-side ventilation pipe 16 is 30 mm and the wall thickness thereof is 2 mm in the example shown in FIG. 42, a ratio of the area of the inner diameter (a diameter of 34 mm) of a distal end portion (on the other ventilation pipe side) to the area of the inner diameter of a proximal end portion (on a connected ventilation pipe side) of each of the first opening portion structure 20g and the second opening portion structure 24g is 1.28 and in a case where the wall thickness is 3 mm, a ratio of the area of the inner diameter of the distal end portion to the area of the inner diameter of the proximal end portion is 1.44. Therefore, each of the first opening portion structure 20g and the second opening portion structure 24g is a structure in which the acoustic impedance sufficiently changes. In a case where each of the first opening portion structure 20g and the second opening portion structure 24g has a configuration including a region in which the wall thickness gradually decreases as in the example shown in FIG. 42, a change in acoustic impedance can be made gentle and the volume of a wind noise can be reduced. In addition, although a configuration in which the inside of the opening portion structure is gradually widened with the outer shape thereof kept constant is desirable, a configuration in which a distal end portion is sharpened may also be adopted.

In addition, each of the first opening portion structure 20g and the second opening portion structure 24g may include a constant-wall-thickness region having a certain length and a region on a distal end side in which the wall thickness gradually decreases as in the example shown in FIG. 42 and may have a configuration including only a region in which the wall thickness gradually decreases.

In addition, a configuration in which the wall thickness of an end portion of the opening portion structure having a cross-sectional shape (an outer shape) of which the size increases as in the examples shown in FIGS. 3 to 12 gradually decreases may also be adopted.

As described above, various shapes may be adopted as the shape of the opening portion structure as long as the acoustic impedance gradually changes therein.

In a case where the cross-sectional shape of the expansion portion 14 is circular, it is preferable that the cross-sectional shape of the opening portion structure is circular as in the examples shown in FIGS. 7 to 9 and in a case where the cross-sectional shape of the expansion portion 14 is rectangular, it is preferable that the cross-sectional shape of the opening portion structure is approximately rectangular as in the examples shown in FIGS. 10 to 12.

The cross-sectional shape of the opening portion structure that is perpendicular to the central axis preferably has two-fold or greater-fold symmetry and more preferably has four-fold or greater-fold symmetry.

In addition, a change in acoustic impedance due to the opening portion structure may be made monotonically, there may be a change in rate of change, and the acoustic impedance may be changed stepwise.

From the viewpoint of suppressing reflection in the case of propagation of a sound from the inlet-side ventilation pipe 12 to the expansion portion 14, a ratio of the minimum acoustic impedance to the maximum acoustic impedance in the opening portion structure is preferably 0.6 or less, more preferably 0.5 or less, and still more preferably 0.35 or less.

In addition, it is preferable that a cutoff frequency fc determined by the shape of the opening portion structure is 2000 Hz or less.

The cutoff frequency fc is determined by the shape and the length of a widening opening portion structure and is expression of a high-pass filter characteristic that a sound of a frequency equal to or higher than fc carries without loss and a sound of a frequency equal to or lower than fc does not propagate by being exponentially reflected in a longitudinal direction.

In the case of an opening portion structure of which the width increases exponentially as shown in FIG. 8, fc=m×c₀/2pi (where c₀ is a sound velocity and pi is the ratio of the circumference of a circle to the diameter thereof) in a case where radius r=r₀×exp (m×x) (where m is a shape constant of the opening portion structure, x is a position in the flow path direction, and r₀ is the radius of an inlet).

Since R=r₀×exp (m×L) (where a is the length of the opening portion structure in the flow path direction and R is the radius of a terminal end of the opening portion structure), m=1/L×ln (R/r₀) and thus fc=c₀×ln (R/r₀)/(2pi×L).

Since a sound of a frequency equal to or higher than fc easily carries in a silencer and is easily absorbed, it is possible to enhance absorption by lowering fc. It is possible to reduce fc by increasing the length L or decreasing the maximum diameter R of the opening portion structure.

Although the opening portion structure of which the width increases exponentially has been described above, the cutoff frequency fc can be obtained in the same manner by solving the wave equation and obtaining a condition for a solution of wave propagation even in the case of other shapes.

In the case of A-weighted sound energy, energy in an audible range is approximately 50% at 2 kHz or less and approximately 50% at 2 kHz or greater. Therefore, 50% of energy can be propagated without loss in a case where fc is 2 kHz or less. Therefore, fc is preferably 2000 Hz or less, more preferably 1250 Hz or less (energy 70%), still more preferably 1000 Hz or less (80%), and most preferably 630 Hz or less (90%).

In addition, although the position of connection to the inlet-side ventilation pipe 12, the position of connection to the first opening portion structure 20, the position of connection to the outlet-side ventilation pipe 16, and the position of connection to the second opening portion structure 24 at side surfaces of the expansion portion 14 are not particularly limited, the positions of connection are preferably positioned at the centers of the side surfaces of the expansion portion 14 as shown in FIG. 3.

In addition, in the example shown in FIG. 3, the central axes of the inlet-side ventilation pipe 12 and the outlet-side ventilation pipe 16 are disposed on the same straight line.

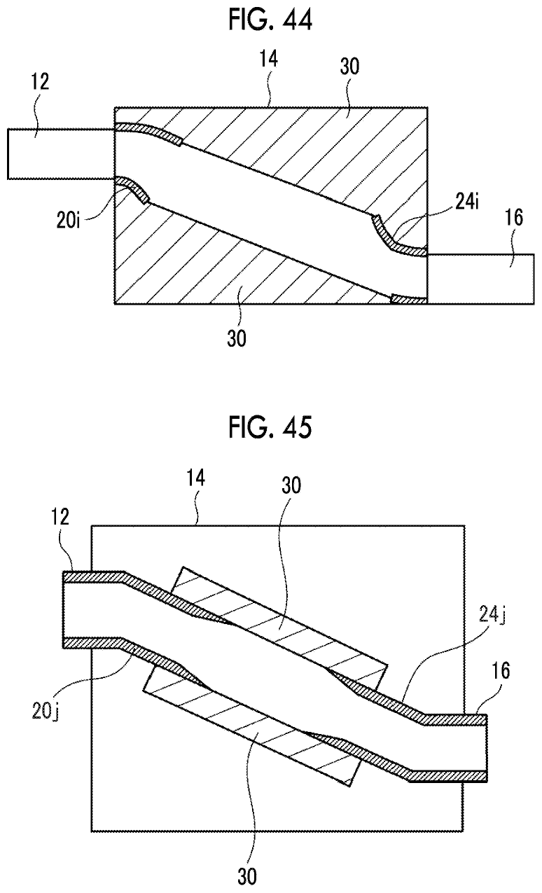

However, the present invention is not limited thereto. For example, as in examples shown in FIG. 43 and FIG. 44, the central axes of the inlet-side ventilation pipe 12 and the outlet-side ventilation pipe 16 may not be disposed on the same straight line. Even in the case of such a configuration, each of the first opening portion structure and the second opening portion structure can be disposed.

In the example shown in FIG. 43, a first opening portion structure 20h has a configuration in which two plate-shaped members are disposed to face each other, the two plate-shaped members are curved such that the flow path is bent to a direction connecting the inlet-side ventilation pipe 12 and the outlet-side ventilation pipe 16 to each other, and a distal end side (the outlet-side ventilation pipe 16 side) of one plate-shaped member has a widening structure (a curved structure) at which the acoustic impedance changes. In addition, a second opening portion structure 24h has a configuration in which two plate-shaped members are disposed to face each other, the two plate-shaped members are curved such that the flow path is bent from the direction connecting the inlet-side ventilation pipe 12 and the outlet-side ventilation pipe 16 to each other to a flow direction of the outlet-side ventilation pipe 16, and a distal end side (the inlet-side ventilation pipe 12 side) of one plate-shaped member has a widening structure (a curved structure) at which the acoustic impedance changes. In the example shown in FIG. 43, each of the first opening portion structure 20h and the second opening portion structure 24h has a configuration in which the one plate-shaped member has a widening structure at which the acoustic impedance changes. However, a configuration in which each of both plate-shaped members has a widening structure (a curved structure) at which the acoustic impedance changes may also be adopted.

Since the flow velocity of wind flowing from the inlet-side ventilation pipe 12 to the outlet-side ventilation pipe 16 increases near an outer side of the flow path bent at an inlet-side portion, as shown in FIG. 43, in a case where a widening structure (a curved structure) at which the acoustic impedance changes is provided near the outer side of the flow path bent at an inlet portion, a flow velocity near the outer side can be particularly lowered, which is desirable for reduction of a wind noise.

In addition, in the case of a first opening portion structure in FIG. 44, two plate-shaped members are different from each other in curvature radius and it is possible to make the acoustic impedance gradually change by increasing the curvature radius or the length of a plate-shaped member near an outer side of the bent flow path.

In addition, even in the case of a configuration in which the central axes of the inlet-side ventilation pipe 12 and the outlet-side ventilation pipe 16 are not on the same straight line, a configuration in which an opening portion structure has a region in which the wall thickness gradually decreases so that the acoustic impedance gradually changes may also be adopted.

In an example shown in FIG. 45, a first opening portion structure 20j is composed of two plate-shaped members and the two plate-shaped members are curved such that the flow path is bent to the direction connecting the inlet-side ventilation pipe 12 and the outlet-side ventilation pipe 16 to each other. In addition, a distal end side (the outlet-side ventilation pipe 16 side) of each of the plate-shaped members constituting the first opening portion structure 20j has a region in which the wall thickness gradually decreases. In addition, a second opening portion structure 24j is composed of two plate-shaped members and the two plate-shaped members are curved such that the flow path is bent from the direction connecting the inlet-side ventilation pipe 12 and the outlet-side ventilation pipe 16 to each other to the flow direction of the outlet-side ventilation pipe 16. In addition, a distal end side (the inlet-side ventilation pipe 12 side) of each of the plate-shaped members has a region in which the wall thickness gradually decreases.

In addition, as shown in FIG. 45, even in the case of a configuration in which the central axes of the inlet-side ventilation pipe 12 and the outlet-side ventilation pipe 16 are not on the same straight line, a configuration in which the space 14a is formed on the rear surface side (a side opposite to the first opening portion structure 20J and the second opening portion structure 24j) of the porous sound absorbing material 30 may also be adopted.

In addition, an average roughness Ra of an inner surface (a surface on a central axis side) of the opening portion structure is preferably 1 mm or less, more preferably 0.5 mm or less, and still more preferably 0.1 mm or less. By reducing the average roughness Ra of the inner surface of the opening portion structure, it is possible to suppress generation of a wind noise that is caused by a vortex resulting from separation of air flowing on a surface of the opening portion structure.

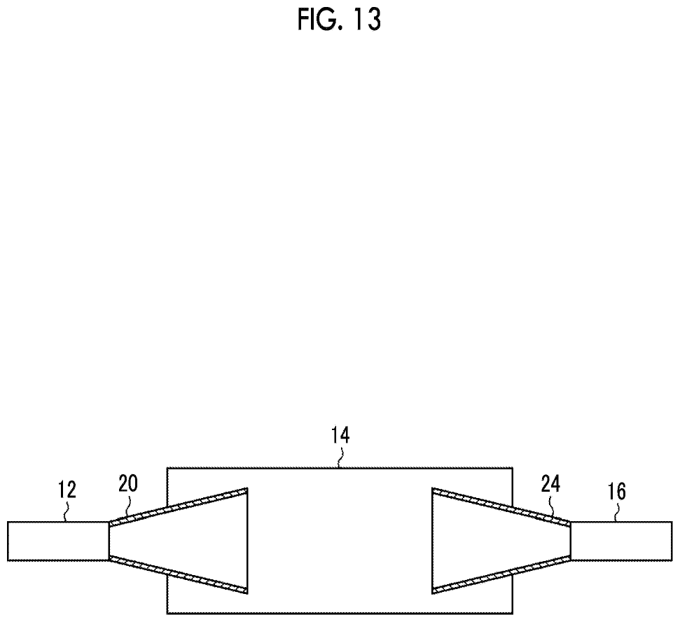

In addition, a change in acoustic impedance in the opening portion structure may continue to the outside of the expansion portion 14. For example, as shown in FIG. 13, the first opening portion structure 20 may be disposed over an area from the inlet-side ventilation pipe 12 to the inside of the expansion portion 14 and may have a shape of which the cross-sectional area increases from an end portion on the inlet-side ventilation pipe 12 side to an end portion to the expansion portion 14 side such that the acoustic impedance gradually decreases between the inlet-side ventilation pipe 12 and the inside of the expansion portion 14.

Similarly, as shown in FIG. 13, the second opening portion structure 24 may be disposed over an area from the inside of the expansion portion 14 to the outlet-side ventilation pipe 16 and may have a shape of which the cross-sectional area increases from an end portion on the expansion portion 14 side to an end portion to the outlet-side ventilation pipe 16 side such that the acoustic impedance gradually decreases between the expansion portion 14 and the inside of the outlet-side ventilation pipe 16. With such a configuration, a change in impedance can be made more gentle.

In addition, in a case where it is assumed that the air passage type silencer according to the aspect of the present invention is used by being connected to a hose, it is desirable that outer surfaces of the inlet portion and the outlet portion of the air passage type silencer have uneven shapes and/or bellows-like shapes. Wind leakage, sound leakage, sound reflection, or the like can be prevented since the air passage type silencer is firmly tightened in a case of being connected to the hose.

In addition, regarding the first rear surface space 22 and the second rear surface space, a ratio between the acoustic impedance in an inlet portion of the rear surface space and the minimum acoustic impedance in the rear surface space is preferably 1.1 or more and more preferably 1.4 or more. In a case where the ratio between the acoustic impedances is 1.1, a frequency at which transmission loss is largest is approximately 5% shifted to a low-frequency side and in a case where the ratio between the acoustic impedances is 1.4, a frequency at which transmission loss is largest is approximately 10% shifted to the low-frequency side and thus low-frequency sound attenuation can be performed more suitably.

This point will be described in Examples which will be described later.

Examples of the materials of the ventilation pipe, the expansion portion, and the opening portion structure include a metal material, a resin material, a reinforced plastic material, and a carbon fiber. Examples of the metal material include metal materials such as aluminum, titanium, magnesium, tungsten, iron, steel, chromium, chromium molybdenum, nichrome molybdenum, and alloys thereof. Examples of the resin material include resin materials such as acrylic resin (PMMA), polymethyl methacrylate, polycarbonate, polyamide, polyalylate, polyetherimide, polyacetal, polyetheretherketone, polyphenylene sulfide, polysulfone, polyethylene terephthalate, polybutylene terephthalate (PET), polyimide, triacetylcellulose (TAC), polypropylene (PP), polyethylene (PE), polystyrene (PS), ABS resin (copolymer synthetic resin of acrylonitrile, butadiene, and styrene), flame-retardant ABS resin, ASA resin (copolymer synthetic resin of acrylonitrile, styrene, and acrylate), polyvinyl chloride (PVC) resin, and polylactic acid (PLA) resin. In addition, examples of the reinforced plastic material include carbon fiber reinforced plastics (CFRP) and glass fiber reinforced plastics (GFRP).

From the viewpoint of weight reduction, easy molding, and the like, it is preferable to use a resin material as the material of the air passage type silencer. In addition, as described above, from the viewpoint of low-frequency range sound insulation, it is preferable to use a material having a high stiffness. From the viewpoint of weight reduction and sound insulation, the density of a member constituting the air passage type silencer is preferably 0.5 g/cm³ to 2.5 g/cm³.

As described above, the air passage type silencer according to the aspect of the present invention may include a sound absorption structure inside the expansion portion.

Examples of the sound absorption structure include a resonance sound absorption structure such as a porous sound absorbing material, a plate or a film with micro through holes (a micro perforated plate (MPP), an air-column resonator, and a Helmholtz resonator.

The porous sound absorbing material is not particularly limited, and a sound absorbing material publicly known in the related art can be used as appropriate. For example, various known sound absorbing materials such as a foaming body, a foaming material (foaming urethane foam (for example, “CALMFLEX F-Series” manufactured by INOAC CORPORATION, urethane foam manufactured by Hikari Co., Ltd., “MIF” manufactured by TOKAI RUBBER INDUSTRIES, Ltd., and the like), flexible urethane foam, a ceramic particle sintered material, phenol foam, melamine foam (“Basotect” (named “Basotect” in Japan) manufactured by BASF SE), a polyamide foam, and the like), a nonwoven fabric sound absorbing material (a microfiber nonwoven fabric (for example, “Thinsulate” manufactured by 3M Company, “MILIFE MF” manufactured by ENEOS Techno Materials Corporation, “Micromat” manufactured by TAHIEI FELT Co., Ltd., and the like), a polyester nonwoven fabric (for example, “White Kyuon” manufactured by TOKYO Bouon, “QonPET” manufactured by Bridgestone KBG Co., Ltd., and “SYNTHEFIBER” manufactured by Toray Industries, Inc.), a plastic nonwoven fabric such as an acrylic fiber nonwoven fabric, a natural fiber nonwoven fabric such as wool and felt, a metal nonwoven fabric, a glass nonwoven fabric, a cellulose nonwoven fabric, and the like), and a material including a minute amount of air (glass wool, rock wool, and a nanofiber-based fiber sound absorbing material (silica nanofiber and acrylic nanofiber (for example, “XAI” manufactured by Mitsubishi Chemical Corporation)) can be used.

In addition, a sound absorbing material having a two-layer configuration with a high-density thin surface nonwoven fabric and a low-density rear surface nonwoven fabric may also be used. Regarding a sound absorbing material provided with a plurality of layers different from each other in density like in the case of a two-layer configuration with a high-density and low-void ratio thin surface nonwoven fabric and a low-density and high-void ratio rear surface nonwoven fabric layer and a case where a polyurethane-based surface coating is attached, it is desirable that a layer of which the density is high (a layer with a low void ratio) is disposed as a flow path surface in the viewpoint of improving fluid characteristics (flow of wind).

As the micro perforated plate, a sound can also be absorbed by means of a plate or a film with innumerable through holes having a diameter of about 100 m such as an aluminum micro perforated plate (SUONO manufactured by DAIKEN CORPORATION) and a vinyl chloride resin micro perforated plate (DI-NOC manufactured by 3M Company) and a rear surface space.

It is desirable that these materials are non-flammable, flame-retardant, and self-extinguishing. In addition, it is also desirable that the entire air passage type silencer is non-flammable, flame-retardant, and self-extinguishing.

### EXAMPLES

Hereinafter, the present invention will be more specifically described based on examples. Materials, used amounts, ratios, treatment contents, treatment procedures, and the like described in the following examples can be appropriately changed without departing from the spirit of the present invention. Therefore, the scope of the present invention should not be construed as being limited to Examples shown below.

### Comparative Example 1

A cylinder having an inner diameter of 80 mm and a length of 200 mm and two discs of which the diameter is the same as the diameter of both edge surfaces of the cylinder and that include holes having a diameter of 28 mm formed in the centers thereof were prepared, the discs were closely attached to both edge surfaces of the cylinder, and the cylinder was acoustically closed by means of tape to manufacture an expansion portion. A cylindrical inlet-side ventilation pipe and a cylinder outlet-side ventilation pipe having an inner diameter of 28 mm and a length of 50 mm were prepared and were connected with the centers of holes in edge surfaces of the expansion portion being aligned with the center of the cylinder. Note that the expansion portion and the ventilation pipes were formed of ABS resin by using a 3D printer (manufactured by XYZ printing, Inc.). The thickness of the ABS resin was 3 mm.

In the expansion portion, a porous sound absorbing material having a thickness of 15 mm (QonPET manufactured by Bridgestone KBG Co., Ltd.) was disposed along an inner wall of the cylinder. In this manner, an air passage type silencer in which air was present in a region having a diameter of 50 mm in the expansion portion and the porous sound absorbing material of 15 mm was present on the outer periphery thereof was manufactured.

Following a transfer matrix measurement method (ASTM E2611) in which an acoustic pipe is used, the transmittance and reflectivity of a sound incident on the air passage type silencer were measured by using a microphone 4-terminal method in which an acoustic pipe is used. While using (1-transmission-reflectivity) as the definition of the absorbance, the absorbance, which is the amount of loss in the air passage type silencer, was obtained.

### Comparative Example 2

Two straight hollow cylinders formed of ABS (having a diameter of 31 mm, an inner diameter of 28 mm, and a length of 50 mm) were prepared and were attached with the centers of openings being aligned with the position of connection to the inlet-side ventilation pipe and the position of connection to the outlet-side ventilation pipe in the expansion portion in Comparative Example 1. In this manner, an air passage type silencer including two straight pipes having a length of 50 mm therein was manufactured. That is, there is no change in acoustic impedance in an opening portion structure in Comparative Example 2.

The absorbance of the manufactured air passage type silencer was obtained in the same manner as in Comparative Example 1.

### Example 1

Two horn-shaped cylinders (having an inner diameter of 28 mm on a narrow side, an inner diameter of 50 mm on a wide side, a length of 50 mm in the flow path direction, and a thickness of 1.5 mm and formed of ABS) of which both sides were open were manufactured by using a 3D printer. An increase in horn diameter was exponential.

An air passage type silencer was manufactured in the same manner as in Comparative Example 1 except that the horn-shaped cylinders were attached, as opening portion structures, to a connection portion with respect to the inlet-side ventilation pipe of the expansion portion and to a connection portion with respect to the outlet-side ventilation pipe of the expansion portion with openings on narrow sides (sides of a diameter of 28 mm) being aligned therewith.

The absorbance of the manufactured air passage type silencer was obtained in the same manner as in Comparative Example 1.

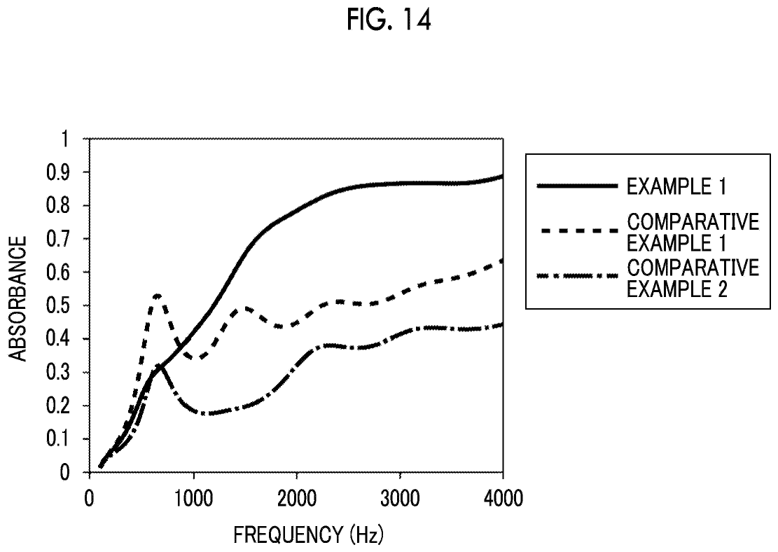

The result is shown in a graph of FIG. 14.

In the case of Comparative Example 1 with no opening portion structure and Comparative Example 2 with the straight pipe-shaped opening portion structures, the absorbance was approximately 50% at the maximum. On the other hand, in the case of Example 1 of the present invention, the higher the frequency was, the larger the absorbance was and the absorbance was 85% or higher at 2000 Hz or higher.

Accordingly, it can be found that it is possible to increase the absorbance in the expansion portion by providing an opening portion structure in which the acoustic impedance gradually changes.

### Examples 2 to 7

Air passage type silencers were manufactured in the same manner as in Example 1 except that the length of the opening portion structures was changed without a change in length of the expansion portion from 200 mm, a change in porous sound absorbing material, and a change in diameter of each opening portion structure at both ends thereof. The length of the opening portion structures was 20 mm in Example 2, 30 mm in Example 3, 40 mm in Example 4, 60 mm in Example 5, 70 mm in Example 6, and 80 mm in Example 7.

For each Example, absorbance evaluation was performed in the same manner.

### Comparative Examples 3 to 8

Opening portion structures were manufactured in the same manner as in Comparative Example 2 except that the length of the opening portion structures was changed. The length of the opening portion structures was 20 mm in Comparative Example 3, 30 mm in Comparative Example 4, 40 mm in Comparative Example 5, 60 mm in Comparative Example 6, 70 mm in Comparative Example 7, and 80 mm in Comparative Example 8.

For each Comparative Example, absorbance evaluation was performed in the same manner.

Regarding the absorbances measured in Examples and Comparative Examples, for comparison between the amounts of absorption at all frequencies, two kinds of indicators which are the average of absorbances at 100 to 4000 Hz (frequency-axis integration was performed logarithmically) and the average of absorbances at 1000 Hz to 4000 Hz were obtained.

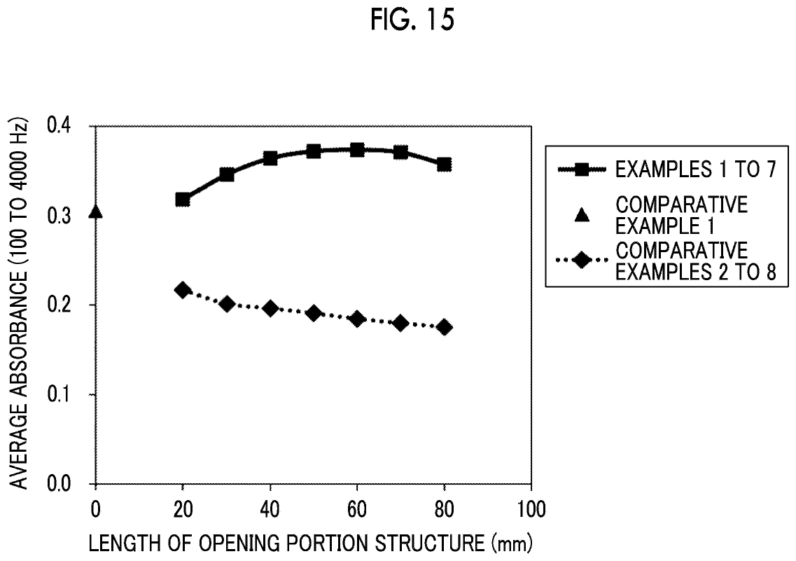

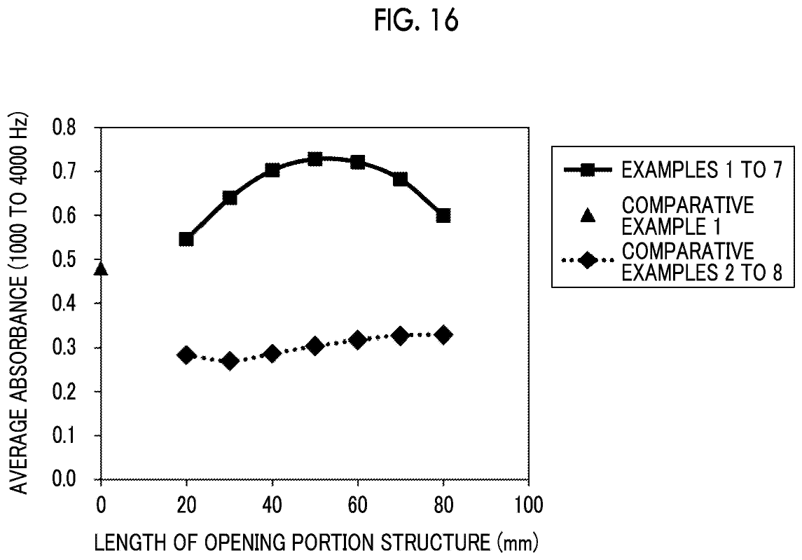

The result is shown in graphs of FIG. 15 and FIG. 16.

It can be found from FIG. 15 and FIG. 16 that providing an opening portion structure in which the acoustic impedance gradually changes results in a high absorbance in comparison with a case where there is no opening portion structure. Meanwhile, it was found that providing a straight pipe-shaped opening portion structure also results in a low absorbance.

It is speculated that, in the case of a straight pipe-shaped opening portion structure, attaching the structure results in a decrease in area of contact with the porous sound absorbing material, which causes the absorbance to be made small uniformly.

In the case of the opening portion structure in which the acoustic impedance gradually changes, the absorbance was highest in the case of a length of 50 mm. As the length of the opening portion structure becomes longer, the effect of suppressing sound reflection at a connection portion between the expansion portion and the ventilation pipe is improved, and the absorbance is increased while the area of contact with the porous sound absorbing material resulting is decreased and thus the absorbance is decreased.

### Comparative Example 9

An air passage type silencer was manufactured in the same manner as in Comparative Example 1 except that the length of the expansion portion was set to 300 mm.

### Examples 8 to 14

Air passage type silencers were manufactured in the same manner as in Examples 1 to 7, except that the length of each expansion portion was set to 300 mm.

### Examples 15 to 19

Air passage type silencers were manufactured in the same manner as in Example 8 except that the lengths of the opening portion structures were set to 90 mm, 100 mm, 110 mm, 120 mm, or 130 mm, respectively.

Absorbance measurement was performed in the same manner as described above for Comparative Example 9 and Examples 8 to 19 and regarding absorbances measured in Examples and Comparative Examples, two kinds of indicators which are the average of absorbances at 100 to 4000 Hz and the average of absorbances at 1000 Hz to 4000 Hz were obtained.

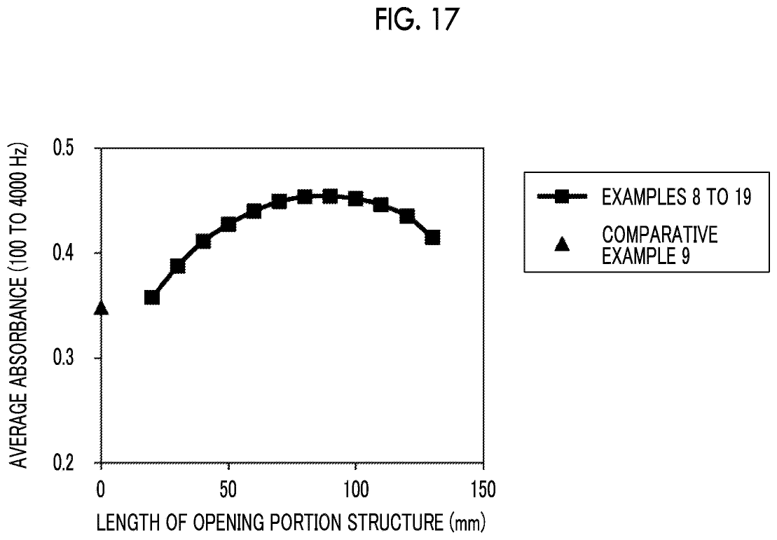

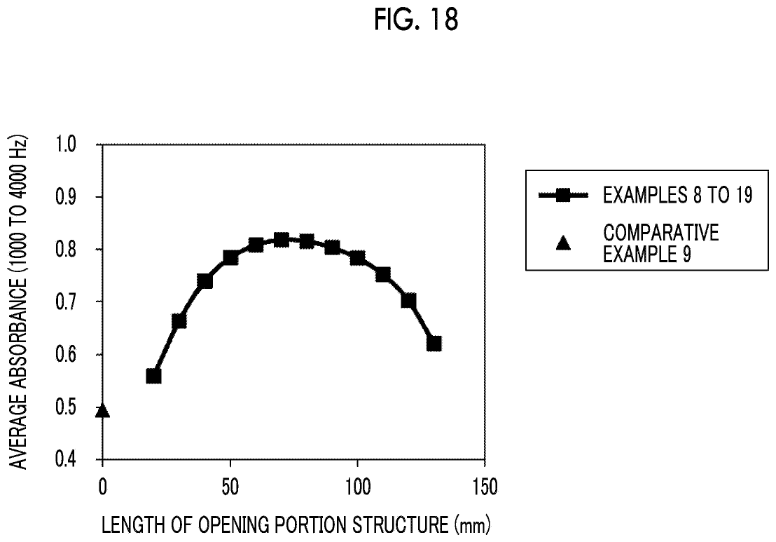

The result is shown in graphs of FIG. 17 and FIG. 18.

It can be found from FIG. 17 and FIG. 18 that providing an opening portion structure in which the acoustic impedance gradually changes results in a high absorbance in comparison with Comparative Example 9 with no opening portion structure. In addition, the absorbance was particularly large in a case where the length of the opening portion structures was about 50 mm to 110 mm, and the absorptance at 1 kHz or greater was largest in a case where the length of the opening portion structures was 70 to 80 mm.

[Simulation]

In order to obtain the ideal resonance characteristics of the air passage type silencer, a simulation was performed by using a finite element method (COMSOL MultiPhysics ver 5.5, COMSOL Inc.).

Transmission loss was obtained for Calculation Example 1 on the same conditions as Comparative Example 1, Calculation Example 2 on the same conditions as Comparative Example 2, Calculation Example 3 on the same conditions as Example 1, Calculation Example 4 on the same conditions as Calculation Example 3 except that the maximum diameter of the opening portion structures was 70 mm. The sound absorbing material was not set for each Calculation Example.

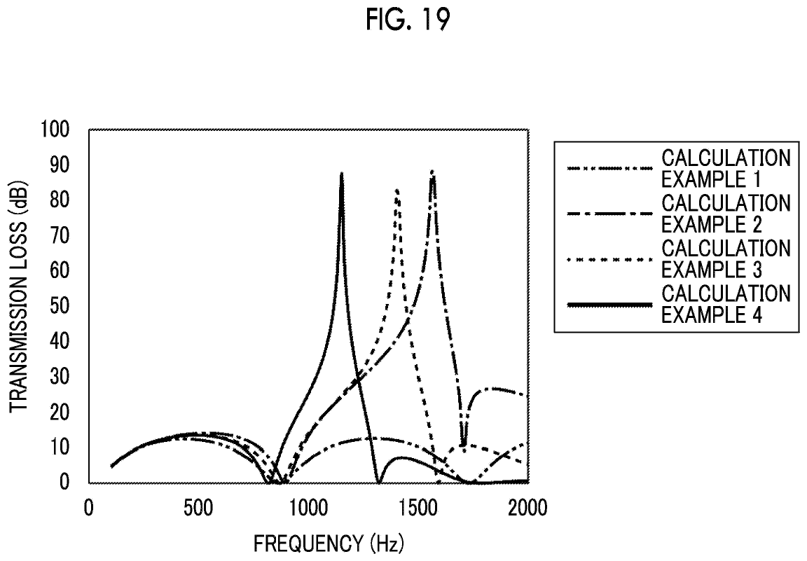

The result is shown in FIG. 19.

Calculation Example 1 with no opening portion structure shows a spectrum with transmission resonance (wavelength λ/2 resonance). In a case where the opening portion structures are attached, rear surface spaces formed between the opening portion structures and a peripheral surface of the expansion portion have resonance and considerably insulate a sound at a specific frequency. In the case of Calculation Example 2 with the straight pipe-shaped tubular opening portion structures, resonance corresponds to resonance of an one-side-closed pipe in which a is approximately λ/4, where a is the length of the opening portion structures. However, it was found from Calculation Example 3 and Calculation Example 4 it is possible to insulate a sound on a lower frequency side by attaching the opening portion structures. Assuming that only a change in opening end correction of inlets of the rear surface spaces contributes to the resonance frequency, the opening end correction becomes larger and the frequency is made lower when the diameter of the opening portion structures is small (when the area of the inlets of the rear surface spaces is large). It was found that the principle of resonance changed since the frequency is made low in a case where the diameter of the opening portion structures is large in practice. The acoustic impedance is the largest at the inlets of the rear surface space because the area thereat is small, and the acoustic impedance is made smaller in the rear surface spaces. Although the structure is different from that of Helmholtz resonance (a structure having a narrow opening portion and a rear surface space), it is speculated that the frequency is lowered by a similar principle.

A shifting amount to a low-frequency side was larger in Calculation Example 4 in which the maximum diameter of the opening portion structures was 70 mm than that in Calculation Example 3 in which the maximum diameter of the opening portion structures was 50 mm. Models were created in which the maximum diameter was changed in a range from 30 mm to 75 mm in increments of 5 mm, and frequencies at which transmission loss was maximized were obtained

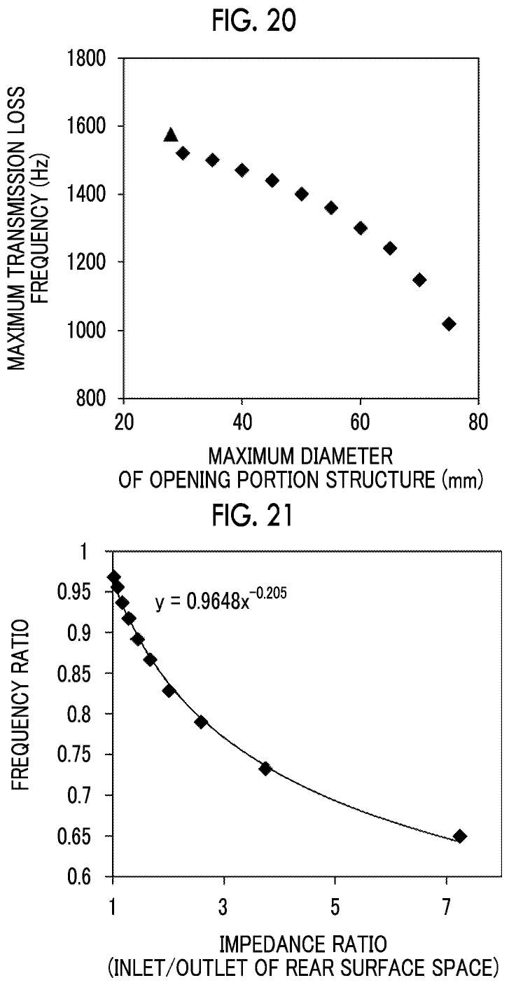

The result is shown in FIG. 20.

With Calculation Example 2 with the straight pipe-shaped opening portion structures as a reference, a graph in which the vertical axis corresponds to a ratio of a resonance frequency to the resonance frequency in Calculation Example 2 and a lateral axis corresponds to a ratio between the acoustic impedance at an inlet of a rear surface space and the acoustic impedance at an outlet is shown in FIG. 21.

It was found that a ratio between frequencies varies as the −0.205th power of a ratio between impedances. Regarding a frequency shifting amount, the ratio between frequencies was 0.95 or less in a case where the ratio between impedances was 1.1 or greater and the ratio between frequencies was 0.90 or less in a case where the ratio between impedances was 1.4 or greater.

Next, the resonance frequency was calculated while changing the lengths of the opening portion structures in Calculation Examples 2 to 4 in a range of 20 mm to 80 mm in increments of 10 mm.

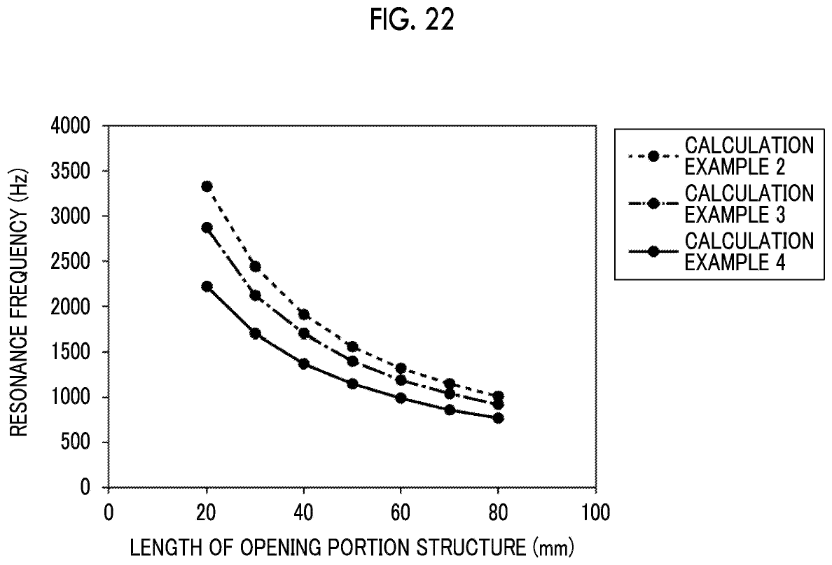

The result is shown in FIG. 22.

It can be found that, regardless of the length, it is possible to insulate a sound on a lower-frequency side in a case where the opening portion structure in which the acoustic impedance gradually changes is provided instead of the case of the straight pipe-shaped opening portion structure. In addition, it can be found that it is possible to insulate a sound on a lower-frequency side in a case where the maximum diameter of the opening portion structure is large, that is, the inlet of the rear surface space is narrow (the acoustic impedance is large).

Accordingly, it can be found that, with the opening portion structure in which the acoustic impedance gradually changes, it is possible to enhance not only the absorbance but also sound insulation on a low-frequency side. The lower a frequency is, the larger a wavelength is and the more a sound is difficult to insulate with a silencer having the same size. However, with the air passage type silencer according to the aspect of the present invention, it is possible to insulate a sound on a low-frequency side without a change in size.

### Comparative Examples 10 to 13

Air passage type silencers in Comparative Examples 10 to 13 of which flow resistivities were adjusted to 1000, 5000, 10000, and 20000 (Pa·s/m²) respectively by performing a tearing process for reduction in density or a pressing process were manufactured by using “Thinsulate” manufactured by 3M Company as the porous sound absorbing material.

The flow resistivities were measured with a self-made device based on ISO 9053. The flow resistivities can also be obtained in the same manner by using a flow resistance measurement system “AirReSys” or the like manufactured by Nihon Onkyo Engineering Co., Ltd.

### Examples 20 to 23

Air passage type silencers in Examples 20 to 23 were manufactured in the same manner as in Comparative Examples 10 to 13 except that the opening portion structures used in Example 1 were attached to the connection portion with respect to the inlet-side ventilation pipe of the expansion portion and to the connection portion with respect to the outlet-side ventilation pipe of the expansion portion.

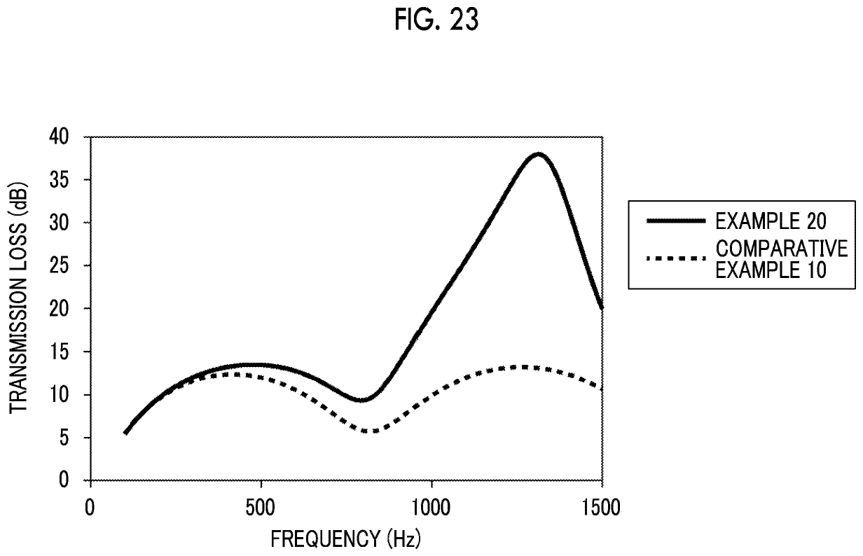

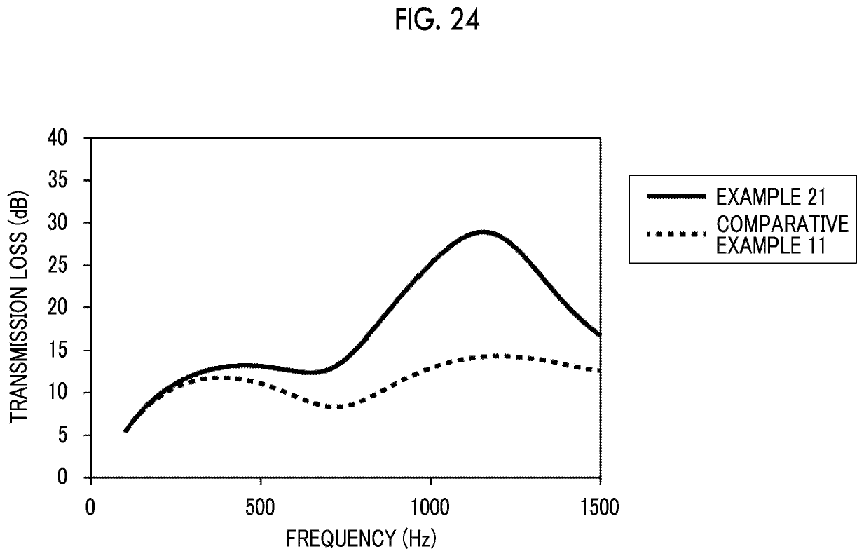

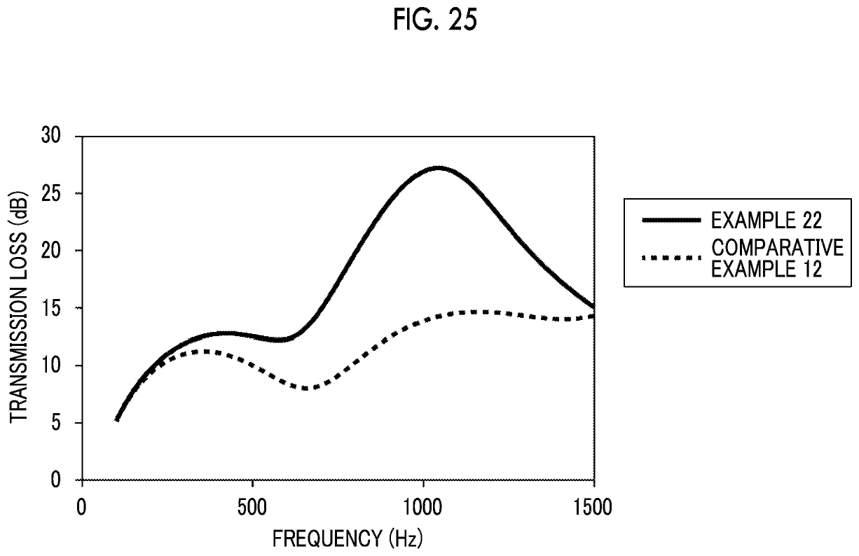

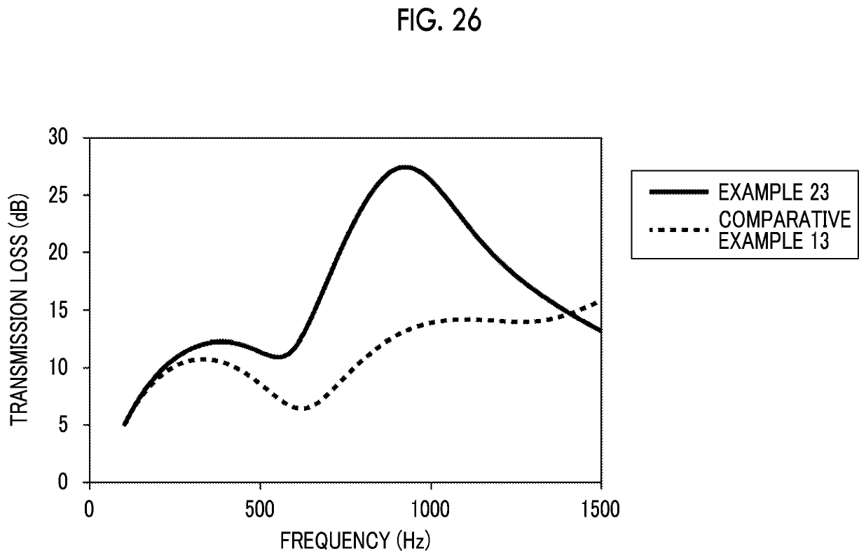

A transmission loss spectrum was obtained for each Example by using the same transfer matrix method as in Comparative Example 1. FIG. 23 to FIG. 26 show transmission loss with the opening portion structure and transmission loss without the opening portion structure related to a case where the same porous sound absorbing material was used. FIG. 23 shows the case of a flow resistivity of 1000 (Pa·s/m²), FIG. 24 shows the case of a flow resistivity of 5000 (Pa·s/m²), and FIG. 25 shows the case of a flow resistivity of 10000 (Pa·s/m²), and FIG. 26 shows the case of a flow resistivity of 20000 (Pa·s/m²).

From FIG. 23 to FIG. 26, it can be found that the transmission loss on the low-frequency side can be increased regardless of the flow resistivity. The larger the flow resistivity was, the more the transmission loss peak was shifted to the low-frequency side. It is speculated that this is because the resonance frequency is shifted more to the low-frequency side since the velocity of a sound in the porous sound absorbing material is lower than the velocity of a sound in air.

### Examples 24 to 26

The porous sound absorbing material was shortened by partially cutting off both end portions of the porous sound absorbing material in Example 22 (in which the flow resistivity was 10000 (Pa·s/m²)) and thus a state where the porous sound absorbing material was not present at ends of the expansion portion was achieved. The cut-off length was 20 mm in Example 24 (the length of the porous sound absorbing material was 160 mm), 40 mm in Example 25 (the length of the porous sound absorbing material was 120 mm), and 60 mm in Example 26 (the length of the porous sound absorbing material was 80 mm). Since the length of the opening portion structure was 50 mm, in Example 26, the porous sound absorbing material was not present in the rear surface spaces.

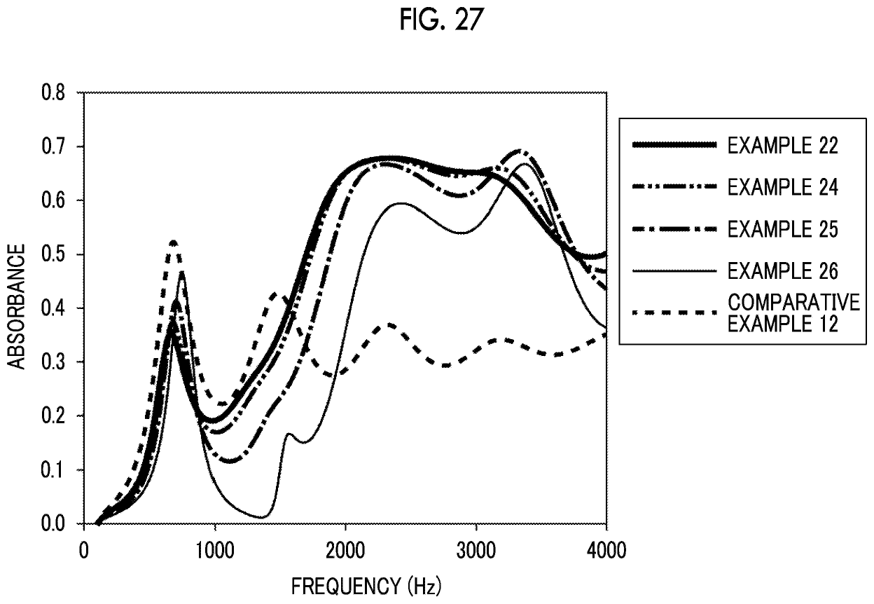

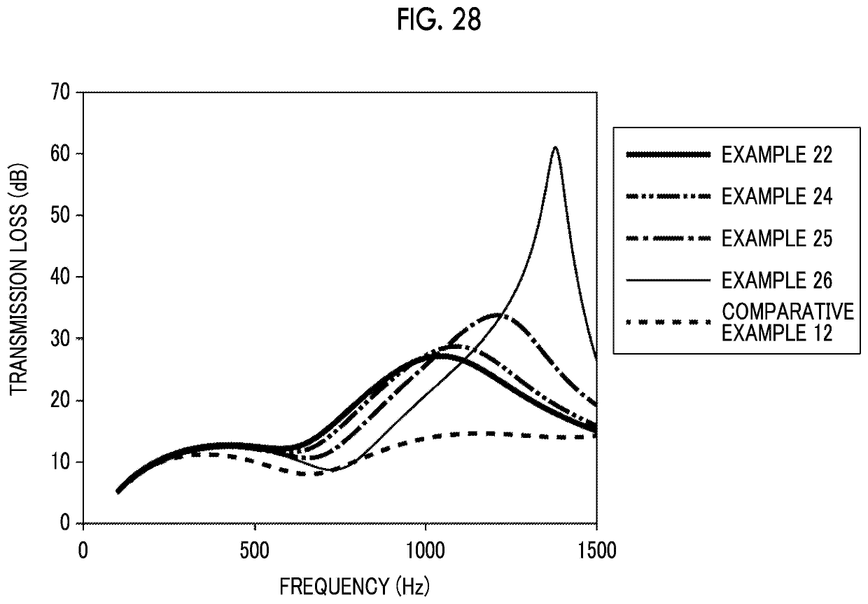

The transmission loss and the absorbances in Examples 24 to 26 were measured by the same method as described above. The result is shown in FIG. 27 and FIG. 28.

From FIG. 27, it can be found that a high absorbance can be achieved even with a portion of the porous sound absorbing material.

In addition, from FIG. 28, it can be found that the resonance effect of the transmission loss due to the rear surface spaces can be seen in any of Examples and can be controlled by the amount of the porous sound absorbing material in the rear surface spaces.

### Examples 27 and 28 and Comparative Example 14

As Example 27, an air passage type silencer was manufactured in the same manner as in Example 1 except that the second opening portion structure was not provided.

As Example 28, an air passage type silencer was manufactured in the same manner as in Example 27 except that the length of the first opening portion structure was set to 100 mm.

As Comparative Example 14, an air passage type silencer was manufactured in the same manner as in Example 1 except that the first opening portion structure was not provided.

The absorbance was measured in the same manner as described above for manufactured Examples 27 and 28 and Comparative Example 14.

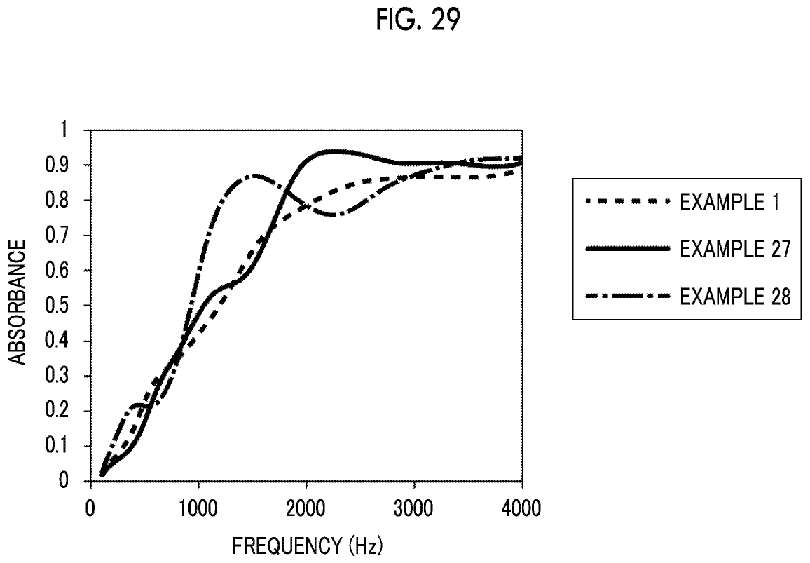

FIG. 29 shows an absorbance graph of Examples 1, 27, and 28.

From FIG. 29, it can be found that the absorbances in Examples 27 and 28 with only the first opening portion structure disposed on the inlet side are higher than the absorbance in Example 1 with the opening portion structures provided on both of an inlet side and an outlet side. In addition, the average sound absorption ratio at 100 to 4000 Hz was 0.38 in Example 27 and 0.42 in Example 28 while the average sound absorption ratio was 0.37 in Example 1.

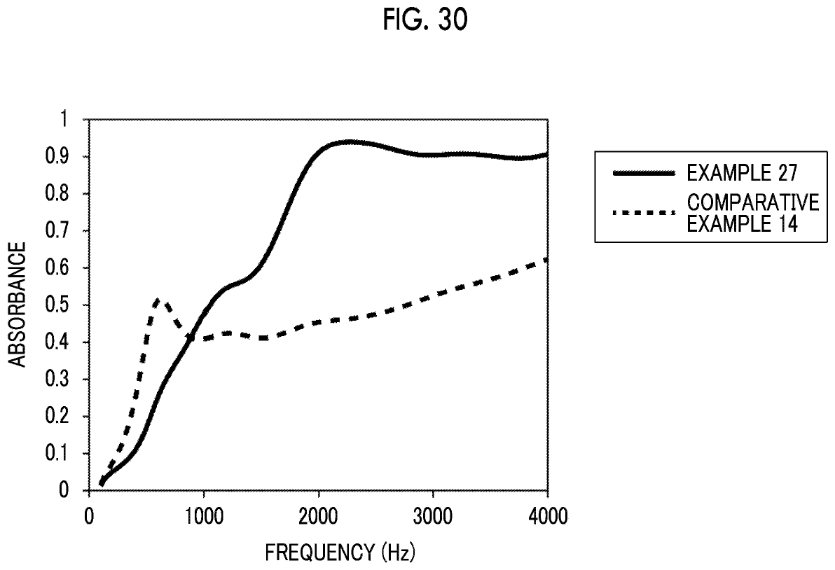

FIG. 30 is an absorbance graph of Example 27 and Comparative Example 14.

From FIG. 30, it can be found that attaching an opening portion structure on the inlet side results in high absorption but attaching the opening portion structure on the outlet side results in an absorbance of approximately 50% even in the case of an opening portion structure having the same structure. It is considered that the absorbance was lowered due to reflection since there was a steep change in acoustic impedance on an inlet side of the expansion portion even in a case where the opening portion structure is attached only on the outlet side.

### Examples 29 and 30

A comparison between air passage type silencers in which the sum of the lengths of the opening portion structures was fixed and the lengths of the first opening portion structure and the second opening portion structure were changed was performed.

In Example 29, an air passage type silencer was manufactured in the same manner as in Example 1 except that the length of the first opening portion structure was set to 70 mm and the length of the second opening portion structure was set to 30 mm.

In Example 30, an air passage type silencer was manufactured in the same manner as in Example 1 except that the length of the first opening portion structure was set to 30 mm and the length of the second opening portion structure was set to 70 mm.

The absorbance and transmission loss in manufactured Examples 29 and 30 were measured by the same method as described above.

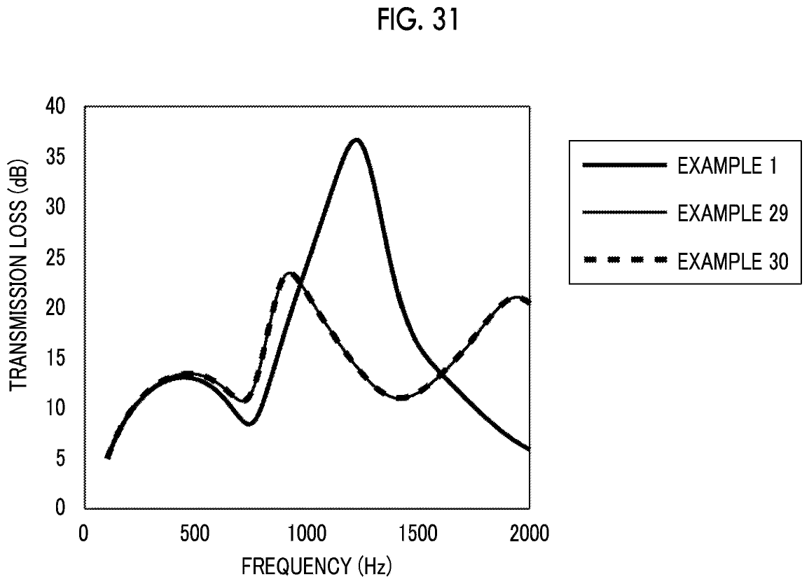

FIG. 31 is a transmission loss graph of Examples 1, 29, and 30.

It can be found from FIG. 31 that changing the lengths of the first opening portion structure and the second opening portion structure results in a change in volume of the rear surface spaces and a change in resonance frequency, which results in a change in transmission loss peak. In addition, in Examples 29 and 30, the lengths of the first opening portion structure and the second opening portion structure were different from each other and the volumes of the rear surface spaces were different from each other. Therefore, there were two transmission loss peaks. In any case, an effect of increasing the transmission loss on a low-frequency side was obtained. In addition, the transmission loss in Example 29 and the transmission loss in Example 30 approximately coincided with each other since the rear surface spaces were only switched between the inlet side and the outlet side.

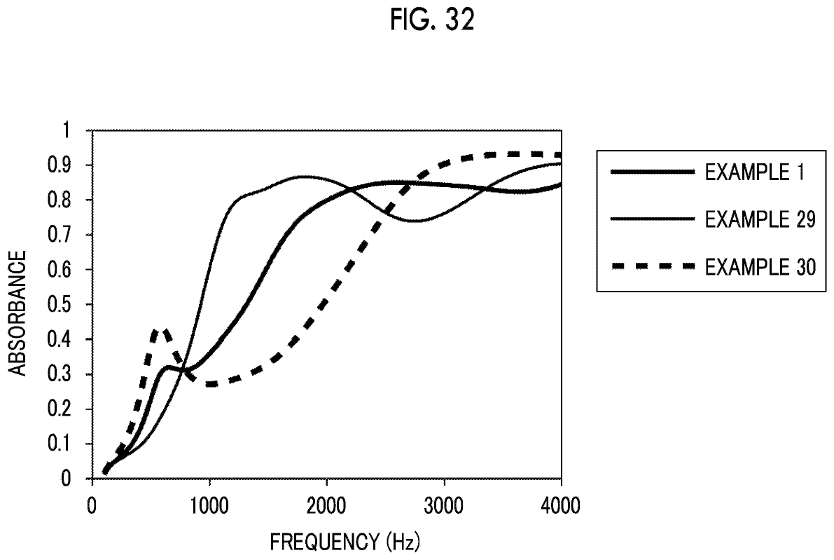

FIG. 32 is an absorbance graph of Examples 1, 29, and 30.

As understood from FIG. 32, in any case, the absorbance was approximately 90% at the maximum. The absorbance in Example 29, in which the length of the first opening portion structure was large, was high even on the low-frequency side. Since it is obvious from Example 27 and Comparative Example 14 that preventing reflection by using the first opening portion structure on the inlet side is important, in a case where the lengths of the two opening portion structures are made different from each other, it is desirable to make the length of the first opening portion structure on the inlet side large.

In addition, in prediction of the volume of a wind noise as follows also, it is desirable to make the length of the first opening portion structure on the inlet side large since a large length of the first opening portion structure on the inlet side results in a small wind noise.

Next, to calculate the amount of generation of a wind noise, fluid calculation (CFD) was performed using a CFD module of COMSOL Inc. A wind speed incident from the inlet-side ventilation pipe was set to 20 m/s, a condition of pressure=0 was set for the outlet side, and a RANS k-ω model was used for turbulent flow calculation. The calculation was performed using a mesh having a sufficiently small size which was particularly fine in the vicinity of a wall.

A wind noise (a turbulent flow noise) is generated in a case where a vortex is generated due to turbulence caused by wind, the vortex generates a smaller vortex, and a minute vortex vibrates. Therefore, as the amounts of wind noise generated in similar structures, comparison was performed with the amount of vortex generation in the air passage type silencer (a volume integral value of a vortex degree).

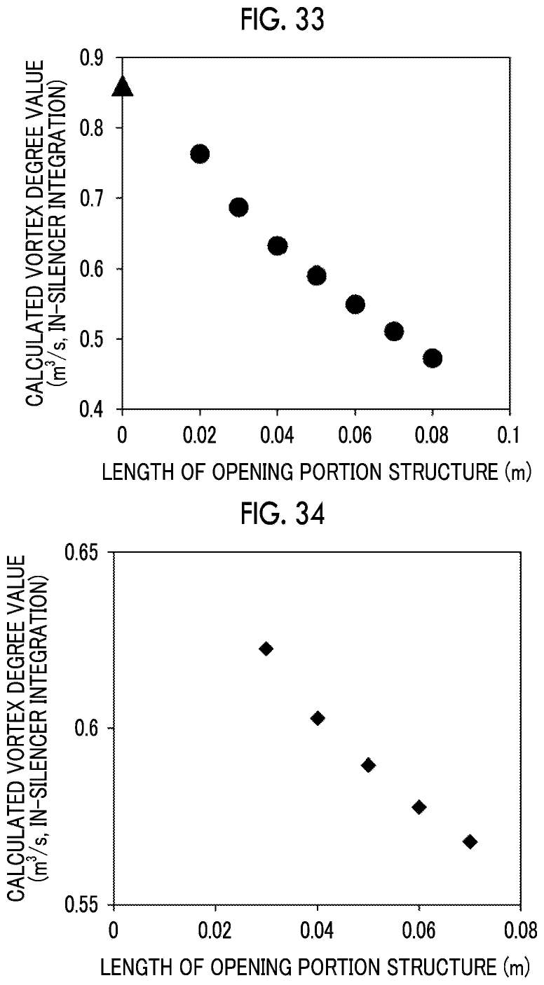

Fluid calculation was performed for the air passage type silencers in Comparative Example 1 and Examples 1 to 7. The result is shown in FIG. 33.

The vortex degree was largest in Comparative Example 1, and the larger the length of the opening portion structure was, the smaller the vortex degree was. It can be found that the volume of the wind noise tends to be small in a case where the length of the opening portion structure is made large so that a change in acoustic impedance is made gentle. Generally, vortices and turbulence are likely to be generated in a place where there is a steep level difference or a steep slope. Therefore, it is speculated that the result is reasonable.

The vortex degree was calculated in the same manner as described above assuming that the sum of the lengths of the first opening portion structure and the second opening portion structure is 100 mm and the length of the first opening portion structure are 30 mm, 40 mm, 50 mm, 60 mm, or 70 mm. The result is shown in FIG. 34.

As understood from FIG. 34, even in a case where the sum of the lengths of the opening portion structures is the same, a large length of the first opening portion structure on the inlet side results in a small vortex degree. That is, it can be found that, by making the first opening portion structure long and making the second opening portion structure short, it is possible to reduce a wind noise while maintaining the area of contact with the porous sound absorbing material in the expansion portion.

### Comparative Examples 15 and 16

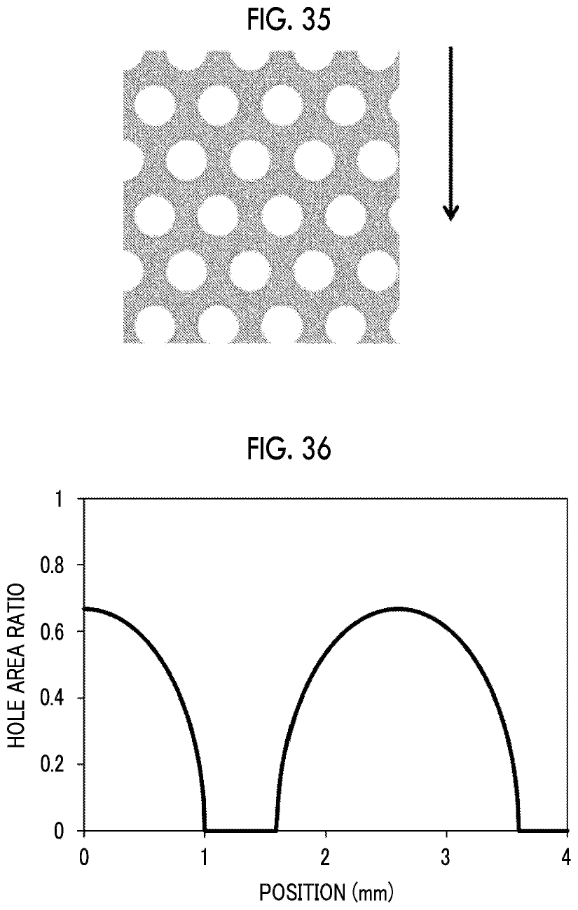

Air passage type silencers were manufactured in the same manner as in Example 1 except that an opening portion structure that consisted of perforated metal as shown in FIG. 35 and that had the same shape as that of the opening portion structure of Example 1 was used.

The opening ratio of the perforated metal was 60%. In Comparative Example 15, the hole diameter was 5.8 mm and the pitch was 10 mm. In Comparative Example 16, the hole diameter was 1.15 mm and the pitch was 2 mm.

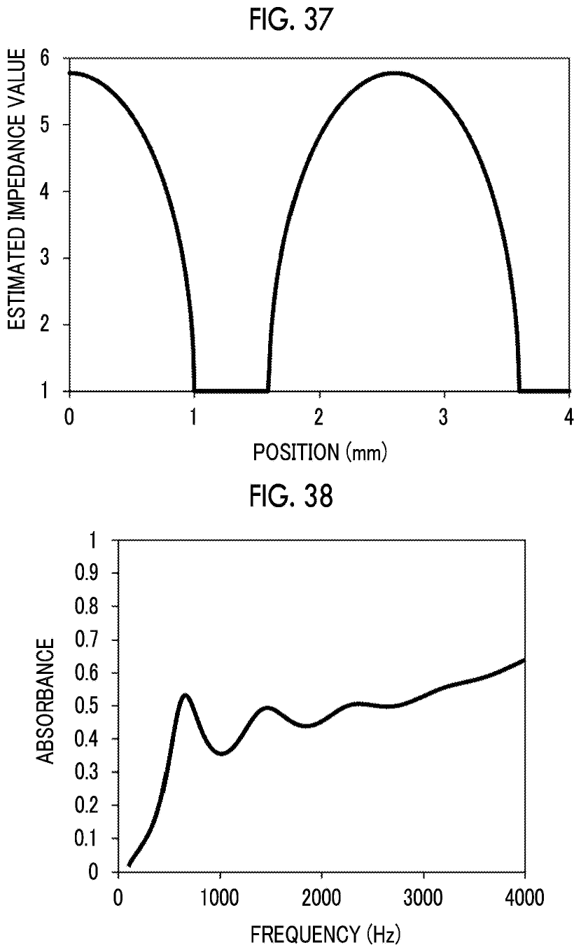

As shown in FIG. 36, the ratio of the area of holes in such perforated metal is repeatedly increased and decreased in the flow path direction. Therefore, in the case of an opening portion structure consisting of the perforated metal, the acoustic impedance greatly increases or decreases in the flow path direction as shown in FIG. 37.

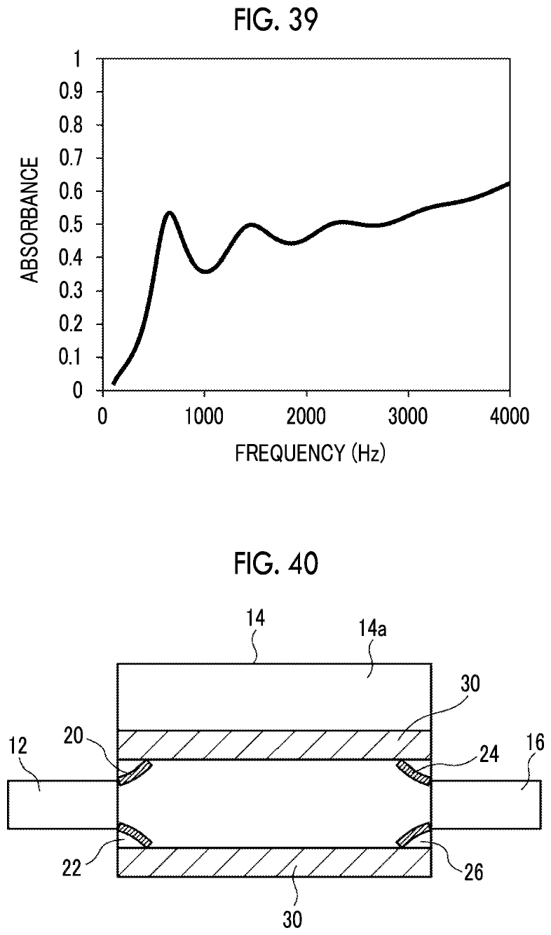

The absorbance was measured in the same as described above for Comparative Examples 15 and 16. The absorbance in Comparative Example 15 is shown in FIG. 38, and the absorbance in Comparative Example 16 is shown in FIG. 39.

In comparison with the absorbance in Example 1, the absorbances in both of Comparative Example 15 and Comparative Example 16 were low and substantially the same as the absorbance in Comparative Example 1 with no opening portion structure. Since the acoustic impedance in the opening portion structure consisting of perforated metal greatly increased and decreased in the flow path direction, there was substantially no reflection reducing effect resulting from impedance matching.

As understood from the above results, the effect of the present invention is obvious.

### EXPLANATION OF REFERENCES

1a, 1b: acoustic impedance change structure
2: inlet portion
3: first impedance matching region
4: acoustic impedance constancy region
5: first terminal structure
6: outlet portion
7: second impedance matching region
8: second terminal structure
10a, 10b: air passage type silencer
12: inlet-side ventilation pipe
14: expansion portion
16: outlet-side ventilation pipe
20: first opening portion structure
20a to 20j: opening portion structure
22: first rear surface space
24, 24g to 24j: second opening portion structure
26: second rear surface space
30: porous sound absorbing material

What is claimed is:

1. An acoustic impedance change structure through which a sound propagates, the acoustic impedance change structure comprising at least in this order:
a first impedance matching region that is connected to an inlet portion and in which an acoustic impedance gradually decreases;
an acoustic impedance constancy region; and
an outlet portion,
wherein Z_{cham}<Zᵢₙ and Z_{cham}<Zₒᵤₜ are satisfied, where Zᵢₙ is an acoustic impedance in the inlet portion, Z_{cham} is an acoustic impedance in the acoustic impedance constancy region, and Zₒᵤₜ is an acoustic impedance in the outlet portion, and
a first terminal structure acoustically connected to the acoustic impedance constancy region is provided.

2. The acoustic impedance change structure according to claim 1,
wherein the first terminal structure is acoustically connected to the acoustic impedance constancy region and the first impedance matching region.

3. The acoustic impedance change structure according to claim 1, further comprising:
a second impedance matching region that is disposed between the acoustic impedance constancy region and the outlet portion, that is connected to the outlet portion, and in which an acoustic impedance gradually increases; and
a second terminal structure that is connected to the acoustic impedance constancy region.

4. An air passage type silencer comprising:
an inlet-side ventilation pipe;
an expansion portion that communicates with the inlet-side ventilation pipe and of which a cross-sectional area is larger than a cross-sectional area of the inlet-side ventilation pipe;
an outlet-side ventilation pipe that communicates with the expansion portion and of which a cross-sectional area is smaller than a cross-sectional area of the expansion portion;
a first opening portion structure in which an acoustic impedance gradually decreases from a connection portion between the expansion portion and the inlet-side ventilation pipe toward an outlet-side ventilation pipe side; and
a first rear surface space that is surrounded by the first opening portion structure, a side surface of the expansion portion that is on an inlet-side ventilation pipe side, and a peripheral surface of the expansion portion and that is open on the outlet-side ventilation pipe side of the expansion portion.

5. The air passage type silencer according to claim 4,
wherein a cutoff frequency fc of the first opening portion structure, which is determined by a shape of the first opening portion structure, is 2000 Hz or less.

6. The air passage type silencer according to claim 4,
wherein 0.2≤a/L≤0.8, where L is a length of the expansion portion and a is a length of the first opening portion structure in a flow path direction of a sound wave in the air passage type silencer.

7. The air passage type silencer according to claim 4, further comprising:
a second opening portion structure of which a cross-sectional area gradually decreases from an inside of the expansion portion toward a connection portion between the expansion portion and the outlet-side ventilation pipe; and
a second rear surface space that is surrounded by the second opening portion structure, a side surface of the expansion portion that is on the outlet-side ventilation pipe side, and the peripheral surface of the expansion portion and that is open on the inlet-side ventilation pipe side of the expansion portion.

8. The air passage type silencer according to claim 7,
wherein a cutoff frequency fc of the second opening portion structure, which is determined by a shape of the second opening portion structure, is 2000 Hz or less.

9. The air passage type silencer according to claim 7,
wherein 0.2≤a₂/L≤0.8, where L is a length of the expansion portion and a₂ is a sum of lengths of the first opening portion structure and the second opening portion structure in a flow path direction of a sound wave in the air passage type silencer.

10. The air passage type silencer according to claim 4,
wherein a ratio between an acoustic impedance in an inlet portion of the rear surface space and a minimum acoustic impedance in the rear surface space is 1.1 or more.

11. The air passage type silencer according to claim 4,
wherein a sound absorption structure is provided in at least a portion of the expansion portion.

12. The air passage type silencer according to claim 11,
wherein the sound absorption structure is a porous sound absorbing material.

13. The air passage type silencer according to claim 11,
wherein at least a portion of the sound absorption structure is disposed along a housing of the expansion portion.

14. The air passage type silencer according to claim 11,
wherein the sound absorption structure is in contact with a maximum diameter portion of at least one of the first opening portion structure or the second opening portion structure.

15. The air passage type silencer according to claim 11,
wherein the sound absorption structure is disposed between the first opening portion structure and the second opening portion structure, and
the sound absorption structure is not disposed in at least one of the first rear surface space or the second rear surface space.

16. The air passage type silencer according to claim 4,
wherein a change in acoustic impedance in at least one of the first opening portion structure or the second opening portion structure continues to an outside of the expansion portion.

17. The air passage type silencer according to claim 4,
wherein an average roughness Ra of an inner surface of at least one of the first opening portion structure or the second opening portion structure is 1 mm or less.

18. The air passage type silencer according to claim 4,
wherein a cross-sectional shape of the expansion portion is circular or rectangular.

19. The air passage type silencer according to claim 4,
wherein the first opening portion structure is not closed in a cross section at an end portion on the outlet-side ventilation pipe side.

20. The air passage type silencer according to claim 7,
wherein the second opening portion structure is not closed in a cross section at an end portion on the inlet-side ventilation pipe side.

21. The air passage type silencer according to claim 4,
wherein the first opening portion structure includes a region in which a wall thickness decreases toward the outlet-side ventilation pipe side.

22. The air passage type silencer according to claim 7,
wherein the second opening portion structure includes a region in which a wall thickness decreases toward the inlet-side ventilation pipe side.

23. The air passage type silencer according to claim 7,
wherein a position of connection to the first opening portion structure and a position of connection to the second opening portion structure at side surfaces of the expansion portion are positioned at centers of the side surfaces.

24. The air passage type silencer according to claim 7,
wherein shapes of the first opening portion structure and the second opening portion structure have two-fold or greater-fold symmetry.

25. The air passage type silencer according to claim 7,
wherein a length of the first opening portion structure is larger than a length of the second opening portion structure in a flow path direction.
